(19) United States
(12) Patent Application Publication
(10) Pub. No.: US 2026/0332370 A1
(43) Pub. Date: Oct. 22, 2026

(54) COMMUNICATION CONFIGURATION TO MITIGATE INTER-BAND SELF-INTERFERENCE

(71) Applicant: QUALCOMM Incorporated, San Diego, CA (US)

(72) Inventors: Qian ZHANG, Basking Ridge, NJ (US); Tao LUO, San Diego, CA (US); Junyi LI, Greentown, PA (US)

(21) Appl. No.: 19/183,353

(22) Filed: Apr. 18, 2025

(51) Int. Cl. H04L 5/00; H04W 36/00; H04W 72/11

(52) U.S. Cl. CPC H04L 5/0098; H04W 36/00692; H04W 72/11

(57) ABSTRACT

Various aspects of the present disclosure generally relate to wireless communication, and to communication configurations to mitigate inter-band self-interference when an uplink resource allocation in a first frequency band includes one or more fundamental frequencies and a downlink resource allocation in a second frequency band includes one or more harmonic frequencies. For example, a network node may provide a user equipment (UE) with separate communication parameters for time intervals with a potential self-interference impact and time intervals without a potential self-interference impact. Accordingly, in a given transmission occasion, the communication parameters that are used may depend on whether there is a potential self-interference impact in a time interval that includes the transmission occasion (for example, according to an implicit determination by the UE as to whether a symbol or slot includes an uplink transmissions and an impacted downlink reception or an explicit indication received from the network node).

### FIELD OF THE DISCLOSURE

Aspects of the present disclosure generally relate to wireless communication and specifically relate to techniques, apparatuses, and methods associated with a communication configuration to mitigate inter-band self-interference.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

As described herein, a network node or a user equipment (UE) operating in a half-duplex mode may perform only one of transmission or reception in a given time interval, such as a slot, a symbol, or other time interval. In various examples, some network nodes or UEs in a wireless communication network may support full-duplex operation in addition to half-duplex operation. In full-duplex operation, a network node or a UE operating in a full-duplex mode (for example, a frequency division duplexing mode, an inter-band carrier aggregation or dual connectivity mode, or a sub-band full-duplexing mode) can transmit and receive communications concurrently (for example, in the same time resources). For example, a network node operating in a full-duplex mode may concurrently receive an uplink communication from a first UE and transmit a downlink communication to a second UE. In another example, a UE operating in a full-duplex mode may concurrently receive a downlink communication and transmit an uplink communication (for example, to the same network node, or to different network nodes). By operating in a full-duplex mode, the capacity of the network and the radio access link may increase, latency may be reduced (for example, by enabling uplink communication in downlink intervals, rather than waiting until a next uplink interval, or vice versa), and spectral efficiency is increased.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, an uplink resource allocation spanning a first set of frequencies in a first frequency band. The processing system may be configured to cause the UE to receive, from the network node, a downlink resource allocation spanning a second set of frequencies in a second frequency band, wherein the second set of frequencies includes one or more harmonic frequencies impacted by self-interference from one or more fundamental frequencies in the first set of frequencies. The processing system may be configured to cause the UE to receive, from the network node, information indicating a first set of communication parameters for time intervals with a potential self-interference impact on the one or more harmonic frequencies and a second set of communication parameters for time intervals without the potential self-interference impact on the one or more harmonic frequencies. The processing system may be configured to cause the UE to communicate with the network node in a transmission occasion using the first set of communication parameters or the second set of communication parameters in accordance with a state of the uplink resource allocation and the downlink resource allocation in a time interval that includes the transmission occasion.

Some aspects described herein relate to a network node. The network node may include a processing system. The processing system may include one or more processors and one or more code-storing memories coupled with the one or more processors. The processing system may be configured to cause the network node to transmit, to a UE, an uplink resource allocation spanning a first set of frequencies in a first frequency band. The processing system may be configured to cause the network node to transmit, to the UE, a downlink resource allocation spanning a second set of frequencies in a second frequency band, wherein the second set of frequencies includes one or more harmonic frequencies impacted by self-interference from one or more fundamental frequencies in the first set of frequencies. The processing system may be configured to cause the network node to transmit, to the UE, information indicating a first set of communication parameters for time intervals with a potential self-interference impact on the one or more harmonic frequencies and a second set of communication parameters for time intervals without the potential self-interference impact on the one or more harmonic frequencies. The processing system may be configured to cause the network node to communicate with the UE in a transmission occasion using the first set of communication parameters or the second set of communication parameters in accordance with a state of the uplink resource allocation and the downlink resource allocation in a time interval that includes the transmission occasion.

Some aspects described herein relate to a method for wireless communication by a UE. The method may include receiving, from a network node, an uplink resource allocation spanning a first set of frequencies in a first frequency band. The method may include receiving, from the network node, a downlink resource allocation spanning a second set of frequencies in a second frequency band, wherein the second set of frequencies includes one or more harmonic frequencies impacted by self-interference from one or more fundamental frequencies in the first set of frequencies. The method may include receiving, from the network node, information indicating a first set of communication parameters for time intervals with a potential self-interference impact on the one or more harmonic frequencies and a second set of communication parameters for time intervals without the potential self-interference impact on the one or more harmonic frequencies. The method may include communicating with the network node in a transmission occasion using the first set of communication parameters or the second set of communication parameters in accordance with a state of the uplink resource allocation and the downlink resource allocation in a time interval that includes the transmission occasion.

Some aspects described herein relate to a method of wireless communication performed by a network node. The method may include transmitting, to a UE, an uplink resource allocation spanning a first set of frequencies in a first frequency band. The method may include transmitting, to the UE, a downlink resource allocation spanning a second set of frequencies in a second frequency band, wherein the second set of frequencies includes one or more harmonic frequencies impacted by self-interference from one or more fundamental frequencies in the first set of frequencies. The method may include transmitting, to the UE, information indicating a first set of communication parameters for time intervals with a potential self-interference impact on the one or more harmonic frequencies and a second set of communication parameters for time intervals without the potential self-interference impact on the one or more harmonic frequencies. The method may include communicating with the UE in a transmission occasion using the first set of communication parameters or the second set of communication parameters in accordance with a state of the uplink resource allocation and the downlink resource allocation in a time interval that includes the transmission occasion.

Some aspects described herein relate to a non-transitory computer-readable medium that stores a set of instructions for wireless communication by a UE. The set of instructions, when executed by one or more processors of the UE, may cause the UE to receive, from a network node, an uplink resource allocation spanning a first set of frequencies in a first frequency band. The set of instructions, when executed by one or more processors of the UE, may cause the UE to receive, from the network node, a downlink resource allocation spanning a second set of frequencies in a second frequency band, wherein the second set of frequencies includes one or more harmonic frequencies impacted by self-interference from one or more fundamental frequencies in the first set of frequencies. The set of instructions, when executed by one or more processors of the UE, may cause the UE to receive, from the network node, information indicating a first set of communication parameters for time intervals with a potential self-interference impact on the one or more harmonic frequencies and a second set of communication parameters for time intervals without the potential self-interference impact on the one or more harmonic frequencies. The set of instructions, when executed by one or more processors of the UE, may cause the UE to communicate with the network node in a transmission occasion using the first set of communication parameters or the second set of communication parameters in accordance with a state of the uplink resource allocation and the downlink resource allocation in a time interval that includes the transmission occasion.

Some aspects described herein relate to a non-transitory computer-readable medium that stores a set of instructions for wireless communication by a network node. The set of instructions, when executed by one or more processors of the network node, may cause the network node to transmit, to a UE, an uplink resource allocation spanning a first set of frequencies in a first frequency band. The set of instructions, when executed by one or more processors of the network node, may cause the network node to transmit, to the UE, a downlink resource allocation spanning a second set of frequencies in a second frequency band, wherein the second set of frequencies includes one or more harmonic frequencies impacted by self-interference from one or more fundamental frequencies in the first set of frequencies. The set of instructions, when executed by one or more processors of the network node, may cause the network node to transmit, to the UE, information indicating a first set of communication parameters for time intervals with a potential self-interference impact on the one or more harmonic frequencies and a second set of communication parameters for time intervals without the potential self-interference impact on the one or more harmonic frequencies. The set of instructions, when executed by one or more processors of the network node, may cause the network node to communicate with the UE in a transmission occasion using the first set of communication parameters or the second set of communication parameters in accordance with a state of the uplink resource allocation and the downlink resource allocation in a time interval that includes the transmission occasion.

Some aspects described herein relate to an apparatus for wireless communication. The apparatus may include means for receiving, from a network node, an uplink resource allocation spanning a first set of frequencies in a first frequency band. The apparatus may include means for receiving, from the network node, a downlink resource allocation spanning a second set of frequencies in a second frequency band, wherein the second set of frequencies includes one or more harmonic frequencies impacted by self-interference from one or more fundamental frequencies in the first set of frequencies. The apparatus may include means for receiving, from the network node, information indicating a first set of communication parameters for time intervals with a potential self-interference impact on the one or more harmonic frequencies and a second set of communication parameters for time intervals without the potential self-interference impact on the one or more harmonic frequencies. The apparatus may include means for communicating with the network node in a transmission occasion using the first set of communication parameters or the second set of communication parameters in accordance with a state of the uplink resource allocation and the downlink resource allocation in a time interval that includes the transmission occasion.

Some aspects described herein relate to an apparatus for wireless communication. The apparatus may include means for transmitting, to a UE, an uplink resource allocation spanning a first set of frequencies in a first frequency band. The apparatus may include means for transmitting, to the UE, a downlink resource allocation spanning a second set of frequencies in a second frequency band, wherein the second set of frequencies includes one or more harmonic frequencies impacted by self-interference from one or more fundamental frequencies in the first set of frequencies. The apparatus may include means for transmitting, to the UE, information indicating a first set of communication parameters for time intervals with a potential self-interference impact on the one or more harmonic frequencies and a second set of communication parameters for time intervals without the potential self-interference impact on the one or more harmonic frequencies. The apparatus may include means for communicating with the UE in a transmission occasion using the first set of communication parameters or the second set of communication parameters in accordance with a state of the uplink resource allocation and the downlink resource allocation in a time interval that includes the transmission occasion.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a semi-persistent scheduling (SPS) configuration and a configured grant (CG) configuration.

FIG. 3 is a diagram illustrating examples of carrier aggregation.

FIG. 4 is a diagram illustrating an example of dual connectivity.

FIG. 5 is a diagram illustrating examples of full-duplex deployment scenarios.

FIG. 6 is a diagram illustrating an example of self-interference in an inter-band full-duplex deployment scenario.

FIG. 7 is a diagram illustrating an example related to a downlink SPS configuration to mitigate inter-band self-interference.

FIG. 8 is a diagram illustrating an example related to an uplink CG configuration to mitigate inter-band self-interference.

FIG. 9 is a flowchart illustrating an example process performed, for example, at a user equipment or an apparatus of a user equipment that supports full-duplex communication.

FIG. 10 is a flowchart illustrating an example process performed, for example, at a network node or an apparatus of a network node that supports full-duplex communication.

FIG. 11 is a diagram of an example apparatus for wireless communication that supports full-duplex communication.

FIG. 12 is a diagram of an example apparatus for wireless communication that supports full-duplex communication.

### DETAILED DESCRIPTION

In a wireless network, one or more devices may be equipped with full-duplex capabilities that enable simultaneous reception and transmission. For example, full-duplex capabilities may be enabled at a network node or a transmission reception point (TRP) to support simultaneous downlink transmission and uplink reception, or at a user equipment (UE) to support simultaneous downlink reception and uplink transmission. In some cases, full-duplex communication may be enabled in an in-band full-duplex (IBFD) mode, where simultaneous transmission and reception occurs in an overlapping frequency bandwidth, a sub-band full-duplex (SBFD) mode, where simultaneous transmission and reception occurs in separate frequency regions on the same carrier, or in a frequency division duplexing (FDD) mode, where simultaneous transmission and reception occurs in paired spectrum using non-overlapping frequency bands separated by a guard band. Additionally or alternatively, simultaneous reception and transmission may occur in separate frequency bands in an inter-band carrier aggregation or dual connectivity configuration, where downlink resources allocated in a first frequency band and uplink resources allocated in a second frequency band overlap in a time domain (for example, when the first frequency band or the second frequency band implement flexible time division duplexing (TDD) that allows uplink and downlink resources to be dynamically allocated within a radio frame). Accordingly, relative to communication in a half-duplex mode, where a device can only transmit or receive in a particular time interval, full-duplex communication may reduce latency, enhance spectral efficiency or throughput, or increase resource utilization efficiency because time and frequency resources can be simultaneously utilized for uplink and downlink.

However, in some cases, enabling full-duplex communication presents various challenges, including self-interference caused by concurrent transmission and reception. For example, self-interference may occur when signal energy from one or more transmit circuits leaks into one or more receive circuits, or when clutter echo causes transmitted signal energy to enter one or more receive circuits after reflecting off one or more objects in a surrounding environment. Full-duplex devices therefore often implement one or more techniques to measure and cancel the self-interference or to otherwise mitigate the self-interference. For example, in full-duplexing modes where downlink and uplink communication occur in separate frequency bands (for example, an FDD mode, an inter-band carrier aggregation mode, or an inter-band dual connectivity mode), a UE may implement a radio frequency (RF) front-end to mitigate interference from a worst case jammer (for example, a signal causing the most interference). Accordingly, because the transmission by the UE can cause a jamming condition at the receiver, the UE may backoff (for example, reduce) an analog-to-digital (ADC) or analog front end (AFE) setpoint according to an assumption that the transmitter is always transmitting.

However, in some cases, inter-band carrier aggregation or dual connectivity may be configured using specific band combinations that can result in relatively high self-interference. For example, uplink transmission in a first frequency band, such as a 3.5 gigahertz (GHz) band, may cause self-interference with respect to downlink reception in a second frequency band, such as a 7 GHz band, due to second harmonics. More particularly, uplink transmission at a fundamental frequency, f₁, can cause intermodulation distortion (IMD) that interferes with downlink reception at a harmonic frequency, f₂=2×f₁. Accordingly, in inter-band carrier aggregation or dual connectivity configurations, self-interference can occur due to second harmonics despite the separation between downlink and uplink frequency resources. Furthermore, mitigating the self-interference in an inter-band carrier aggregation or dual connectivity configuration poses challenges due to non-uniform leakage or interference from the uplink frequency resources to the downlink frequency resources. For example, uplink transmission at certain frequencies may not have a self-interference impact when downlink resources are not harmonic frequencies of the transmission frequencies.

Various aspects relate generally to communication configurations to mitigate inter-band self-interference when an uplink resource allocation in a first frequency band includes one or more fundamental frequencies and a downlink resource allocation in a second frequency band includes one or more harmonic frequencies of the one or more fundamental frequencies. Some aspects more specifically relate to a network node providing a UE with one or more communication configurations that include a first set of communication parameters for time intervals with a potential self-interference impact and a second set of communication parameters for time intervals without a potential self-interference impact. For example, in some aspects, the one or more communication configurations may include a downlink semi-persistent scheduling (SPS) configuration or an uplink configured grant (CG) configuration. Accordingly, in a given SPS or CG transmission occasion, the UE may apply either the first set of communication parameters or the second set of communication parameters depending on the self-interference impact in a time interval that includes the SPS or CG transmission occasion (for example, according to an implicit determination by the UE as to whether a symbol or slot includes an uplink transmission and an impacted downlink reception, or an explicit indication received from the network node). In some aspects, the communication parameters for the time intervals with the potential self-interference impact may be configured as offsets relative to the communication parameters for the time intervals without the potential self-interference impact. Furthermore, in some aspects, a dynamically scheduled transmission may include a scheduling offset that is sufficiently large to allow the UE to decode the dynamic grant and change parameters as-needed before the transmission occurs. In addition, in CG transmission occasions where the UE does not have uplink data to transmit, the UE may transmit a CG skipping indication to the network node and apply the parameters for the time intervals without a self-interference impact, or the network node may adjust downlink scheduling according to the CG skipping indication.

Particular aspects of the subject matter described in this disclosure can be implemented to realize one or more of the following potential advantages. In some examples, the described techniques can be used to mitigate self-interference in inter-band communication scenarios where an uplink resource allocation includes one or more fundamental frequencies and a downlink resource allocation includes one or more harmonic frequencies. For example, by providing a set of SPS or CG communication parameters for time intervals with a potential self-interference impact, the described techniques can adjust uplink (for example, CG) parameters or downlink (for example, SPS) parameters to reduce the self-interference impact of an uplink transmission or improve demodulation and decoding performance for the reception of the concurrent downlink transmission. In addition, by providing a set of SPS or CG communication parameters for time intervals without a potential self-interference impact, the described techniques can employ uplink or downlink communication parameters in accordance with a non-uniform self-interference impact from the uplink frequency allocation to the downlink frequency allocation. In other examples, by providing dynamic grants with large scheduling offsets (for example, K1 or K0 offsets), the described techniques allow a UE to decode the dynamic grants, determine a potential self-interference impact in a time interval of the dynamically scheduled transmission, and change communication parameters as-needed before the dynamically scheduled transmission occurs. In this way, the described techniques may enable a network node and a UE to exploit efficiencies such as reduced latency, increased throughput, or increased spectral efficiency in intervals with a potential self-interference impact, and exploit efficiencies such as reduced interference cancellation or scheduling complexity, or higher power or more reliable transmission in intervals with no potential self-interference impact.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

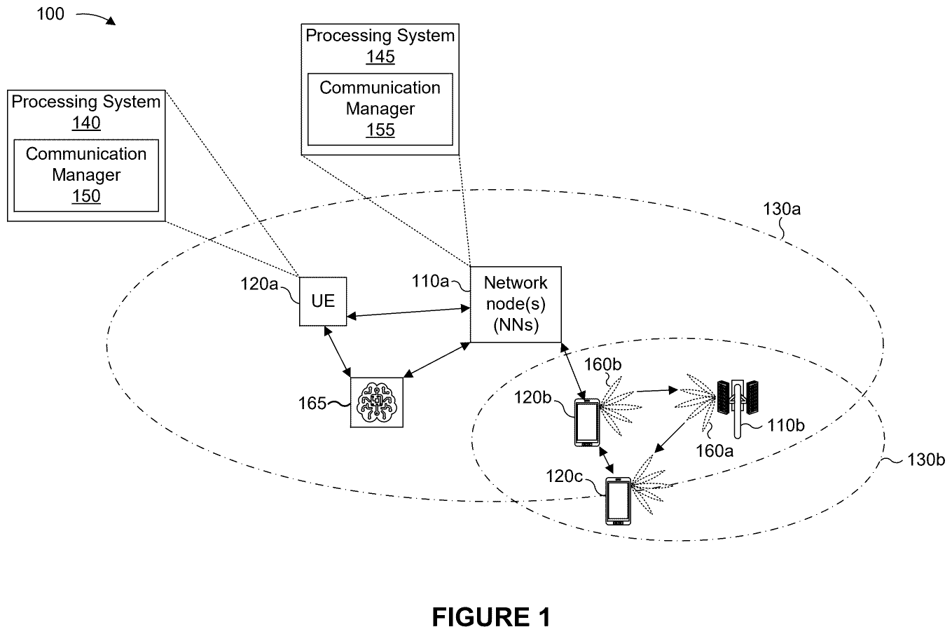

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR 4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, ADCs, or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a TRP, a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve FDD, inter-band carrier aggregation, or inter-band dual connectivity, where downlink transmissions are in a first frequency band or on a first component carrier and uplink transmissions are in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive, from a network node 110, an uplink resource allocation spanning a first set of frequencies in a first frequency band; receive, from the network node 110, a downlink resource allocation spanning a second set of frequencies in a second frequency band, wherein the second set of frequencies includes one or more harmonic frequencies impacted by self-interference from one or more fundamental frequencies in the first set of frequencies; receive, from the network node 110, information indicating a first set of communication parameters for time intervals with a potential self-interference impact on the one or more harmonic frequencies and a second set of communication parameters for time intervals without the potential self-interference impact on the one or more harmonic frequencies; and communicate with the network node 110 in a transmission occasion using the first set of communication parameters or the second set of communication parameters in accordance with a state of the uplink resource allocation and the downlink resource allocation in a time interval that includes the transmission occasion. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, an uplink resource allocation spanning a first set of frequencies in a first frequency band; transmit, to the UE 120, a downlink resource allocation spanning a second set of frequencies in a second frequency band, wherein the second set of frequencies includes one or more harmonic frequencies impacted by self-interference from one or more fundamental frequencies in the first set of frequencies; transmit, to the UE 120, information indicating a first set of communication parameters for time intervals with a potential self-interference impact on the one or more harmonic frequencies and a second set of communication parameters for time intervals without the potential self-interference impact on the one or more harmonic frequencies; and communicate with the UE 120 in a transmission occasion using the first set of communication parameters or the second set of communication parameters in accordance with a state of the uplink resource allocation and the downlink resource allocation in a time interval that includes the transmission occasion. Additionally, or alternatively, the communication manager 155 may perform one or more other operations described herein.

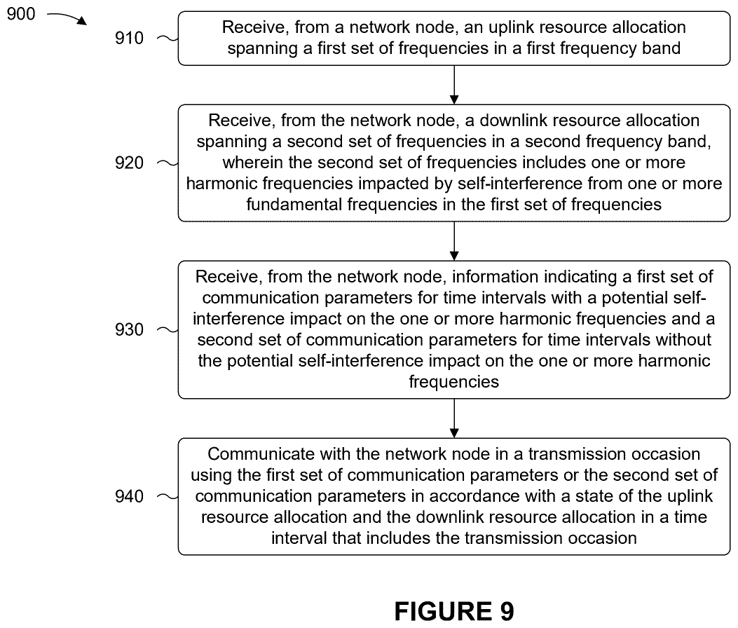

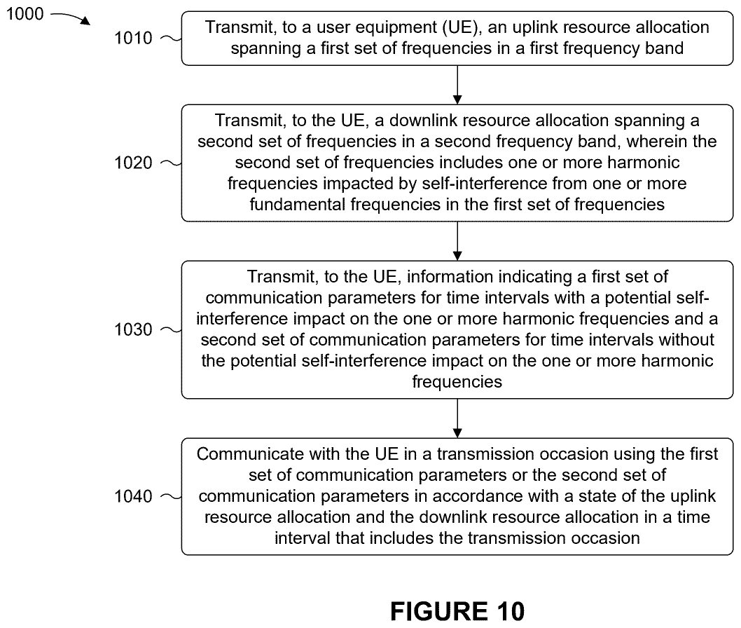

The network node 110, the processing system 145 of the network node 110, the UE 120, the processing system 140 of the UE 120, or any other component(s) of FIG. 1 may implement one or more techniques or perform one or more operations associated with a communication configuration to mitigate inter-band self-interference, as described in more detail elsewhere herein. For example, the processing system 145 of the network node 110, or the processing system 140 of the UE 120, may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

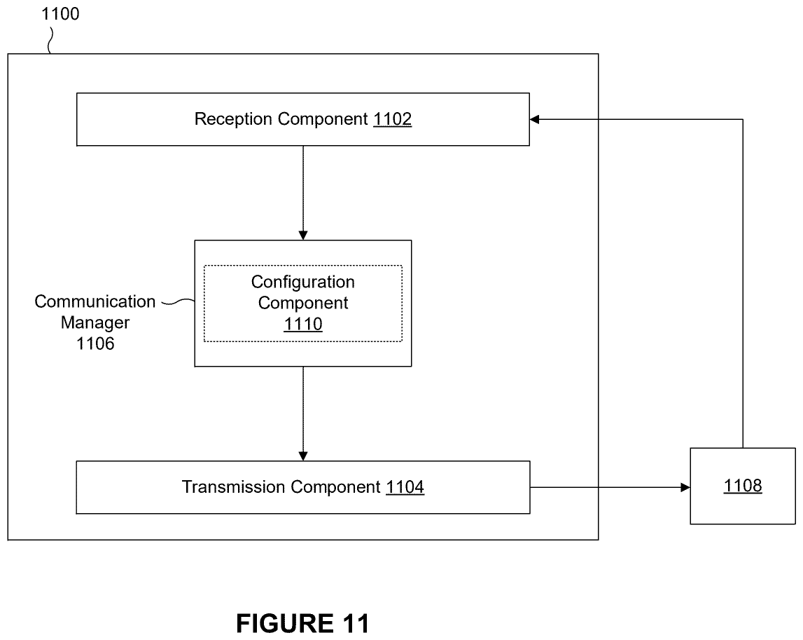

In some aspects, the UE 120 includes means for receiving, from a network node 110, an uplink resource allocation spanning a first set of frequencies in a first frequency band; means for receiving, from the network node 110, a downlink resource allocation spanning a second set of frequencies in a second frequency band, wherein the second set of frequencies includes one or more harmonic frequencies impacted by self-interference from one or more fundamental frequencies in the first set of frequencies; means for receiving, from the network node 110, information indicating a first set of communication parameters for time intervals with a potential self-interference impact on the one or more harmonic frequencies and a second set of communication parameters for time intervals without the potential self-interference impact on the one or more harmonic frequencies; or means for communicating with the network node 110 in a transmission occasion using the first set of communication parameters or the second set of communication parameters in accordance with a state of the uplink resource allocation and the downlink resource allocation in a time interval that includes the transmission occasion. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

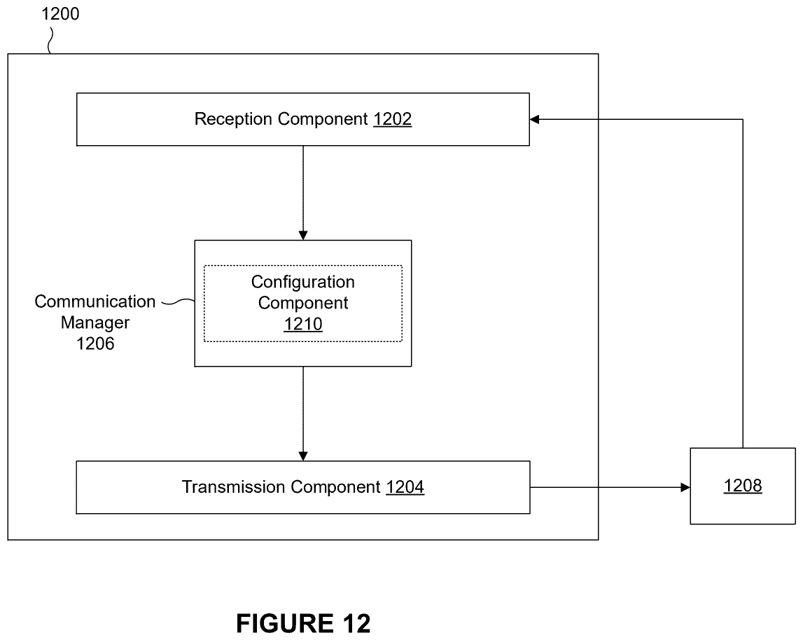

In some aspects, the network node 110 includes means for transmitting, to a UE 120, an uplink resource allocation spanning a first set of frequencies in a first frequency band; means for transmitting, to the UE 120, a downlink resource allocation spanning a second set of frequencies in a second frequency band, wherein the second set of frequencies includes one or more harmonic frequencies impacted by self-interference from one or more fundamental frequencies in the first set of frequencies; means for transmitting, to the UE 120, information indicating a first set of communication parameters for time intervals with a potential self-interference impact on the one or more harmonic frequencies and a second set of communication parameters for time intervals without the potential self-interference impact on the one or more harmonic frequencies; or means for communicating with the UE 120 in a transmission occasion using the first set of communication parameters or the second set of communication parameters in accordance with a state of the uplink resource allocation and the downlink resource allocation in a time interval that includes the transmission occasion. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

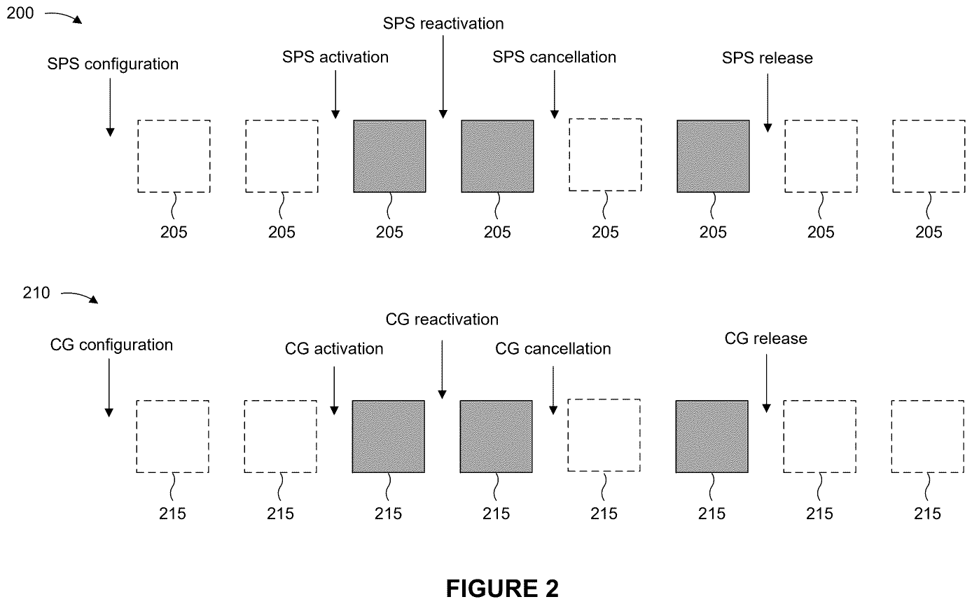

FIG. 2 is a diagram illustrating an example 200 of downlink SPS communication and an example 210 of uplink CG communication. SPS communications may include periodic downlink communications that are configured for a UE 120, such that a network node 110 does not need to transmit (for example, directly or via one or more network nodes 110) separate DCI to schedule each downlink communication, thereby conserving signaling overhead. CG communications may include periodic uplink communications that are configured for a UE 120, such that the network node 110 does not need to transmit (for example, directly or via one or more network nodes) separate DCI to schedule each uplink communication, thereby conserving signaling overhead.

As shown in example 200, a UE 120 may be configured with an SPS configuration for SPS communications. For example, the UE 120 may receive the SPS configuration via an RRC message transmitted by a network node 110 (for example, directly to the UE 120 or via one or more network nodes 110). The SPS configuration may indicate a downlink resource allocation associated with SPS downlink communications (for example, in a time domain, frequency domain, spatial domain, or code domain) and a periodicity at which the downlink resource allocation is repeated, resulting in periodically reoccurring scheduled SPS occasions 205 for the UE 120. The SPS configuration may also configure HARQ-ACK feedback resources for the UE 120 to transmit HARQ-ACK feedback for SPS PDSCH communications received in the SPS occasions 205. For example, the SPS configuration may indicate a PDSCH-to-HARQ feedback timing value, which may be referred to as a K1 value in a wireless communication standard (for example, a 3GPP standard).

The network node 110 may transmit SPS activation DCI to the UE 120 (for example, directly or via one or more network nodes 110) to activate the SPS configuration for the UE 120. The network node 110 may indicate, in the SPS activation DCI, communication parameters, such as an MCS, an RB allocation, or antenna ports, for the SPS PDSCH communications to be transmitted in the scheduled SPS occasions 205. The UE 120 may begin monitoring the SPS occasions 205 responsive to receiving the SPS activation DCI. For example, beginning with a next scheduled SPS occasion 205 subsequent to receiving the SPS activation DCI, the UE 120 may monitor the scheduled SPS occasions 205 to decode PDSCH communications using the communication parameters indicated in the SPS activation DCI. The UE 120 may refrain from monitoring configured SPS occasions 205 prior to receiving the SPS activation DCI.

The network node 110 may transmit SPS reactivation DCI to the UE 120 (for example, directly or via one or more network nodes) to change the communication parameters for the SPS PDSCH communications. Responsive to receiving the SPS reactivation DCI, the UE 120 may begin monitoring the scheduled SPS occasions 205 using the communication parameters indicated in the SPS reactivation DCI. For example, beginning with a next scheduled SPS occasion 205 subsequent to receiving the SPS reactivation DCI, the UE 120 may monitor the scheduled SPS occasions 205 to decode PDSCH communications based on the communication parameters indicated in the SPS reactivation DCI.

In some cases, such as when there is no downlink traffic to transmit to the UE 120, the network node 110 may transmit SPS cancellation DCI to the UE 120 (for example, directly or via one or more network nodes) to temporarily cancel or deactivate one or more subsequent SPS occasions 205 for the UE 120. The SPS cancellation DCI may deactivate only a subsequent one SPS occasion 205 or a subsequent N SPS occasions 205 (where N is an integer). SPS occasions 205 after the one or more SPS occasions 205 subsequent to the SPS cancellation DCI may remain activated. Responsive to receiving the SPS cancellation DCI, the UE 120 may refrain from monitoring the one or more (for example, N) SPS occasions 205 subsequent to receiving the SPS cancellation DCI. As shown in example 200, the SPS cancellation DCI cancels one subsequent SPS occasion 205 for the UE 120. After the SPS occasion 205 (or N SPS occasions) subsequent to receiving the SPS cancellation DCI, the UE 120 may automatically resume monitoring the scheduled SPS occasions 205.

The network node 110 may transmit SPS release DCI to the UE 120 (for example, directly or via one or more network nodes 110) to deactivate the SPS configuration for the UE 120. The UE 120 may stop monitoring the scheduled SPS occasions 205 responsive to the SPS release DCI. For example, the UE 120 may refrain from monitoring any scheduled SPS occasions 205 until another SPS activation DCI is received by the UE 120. Whereas the SPS cancellation DCI may deactivate only a subsequent one SPS occasion 205 or a subsequent N SPS occasions 205, the SPS release DCI deactivates all subsequent SPS occasions 205 for a given SPS configuration for the UE 120 until the given SPS configuration is activated again by a new SPS activation DCI.

As shown in example 210, a UE 120 may be configured with a CG configuration for CG communications. For example, the UE 120 may receive the CG configuration via an RRC message transmitted by a network node 110 (for example, directly to the UE 120 or via one or more network nodes 110). The CG configuration may indicate an uplink resource allocation associated with CG uplink communications (for example, in a time domain, frequency domain, spatial domain, or code domain) and a periodicity at which the uplink resource allocation is repeated, resulting in periodically reoccurring scheduled CG occasions 215 for the UE 120. In some examples, the CG configuration may identify a resource pool or multiple resource pools that are available to the UE 120 for an uplink transmission. The CG configuration may configure contention-free CG communications (for example, where resources are dedicated for the UE 120 to transmit uplink communications) or contention-based CG communications (for example, where the UE 120 contends for access to a channel in the configured resource allocation, such as by using a channel access procedure or a channel sensing procedure).

The network node 110 may transmit CG activation DCI to the UE 120 (for example, directly or via one or more network nodes 110) to activate the CG configuration for the UE 120. The network node 110 may indicate, in the CG activation DCI, communication parameters, such as an MCS, an RB allocation, or antenna ports, for the CG PUSCH communications to be transmitted in the scheduled CG occasions 215. The UE 120 may begin transmitting in the CG occasions 215 responsive to the CG activation DCI. For example, beginning with a next scheduled CG occasion 215 subsequent to receiving the CG activation DCI, the UE 120 may transmit a PUSCH communication in the scheduled CG occasions 215 using the communication parameters indicated in the CG activation DCI. The UE 120 may refrain from transmitting in configured CG occasions 215 prior to receiving the CG activation DCI.

The network node 110 may transmit CG reactivation DCI to the UE 120 (for example, directly or via one or more network nodes 110) to change the communication parameters for the CG PUSCH communications. Responsive to receiving the CG reactivation DCI, the UE 120 may begin transmitting in the scheduled CG occasions 215 using the communication parameters indicated in the CG reactivation DCI. For example, beginning with a next scheduled CG occasion 215 subsequent to receiving the CG reactivation DCI, the UE 120 may transmit PUSCH communications in the scheduled CG occasions 215 based at least in part on the communication parameters indicated in the CG reactivation DCI.

In some cases, such as when the network node 110 needs to override a scheduled CG communication for a higher priority communication, the network node 110 may transmit CG cancellation DCI to the UE 120 (for example, directly or via one or more network nodes) to temporarily cancel or deactivate one or more subsequent CG occasions 215 for the UE 120. The CG cancellation DCI may deactivate only a subsequent one CG occasion 215 or a subsequent N CG occasions 215 (where N is an integer). CG occasions 215 after the one or more (for example, N) CG occasions 215 subsequent to the CG cancellation DCI may remain activated. Responsive to receiving the CG cancellation DCI, the UE 120 may refrain from transmitting in the one or more (for example, N) CG occasions 215 subsequent to receiving the CG cancellation DCI. As shown in example 210, the CG cancellation DCI cancels one subsequent CG occasion 215 for the UE 120. After the CG occasion 215 (or N CG occasions) subsequent to receiving the CG cancellation DCI, the UE 120 may automatically resume transmission in the scheduled CG occasions 215.

The network node 110 may transmit CG release DCI to the UE 120 (for example, directly or via one or more network nodes) to deactivate the CG configuration for the UE 120. The UE 120 may stop transmitting in the scheduled CG occasions 215 responsive to receiving the CG release DCI. For example, the UE 120 may refrain from transmitting in any scheduled CG occasions 215 until another CG activation DCI is received by the UE 120. Whereas the CG cancellation DCI may deactivate only a subsequent one CG occasion 215 or a subsequent N CG occasions 215, the CG release DCI deactivates all subsequent CG occasions 215 for a given CG configuration for the UE 120 until the given CG configuration is activated again by a new CG activation DCI.

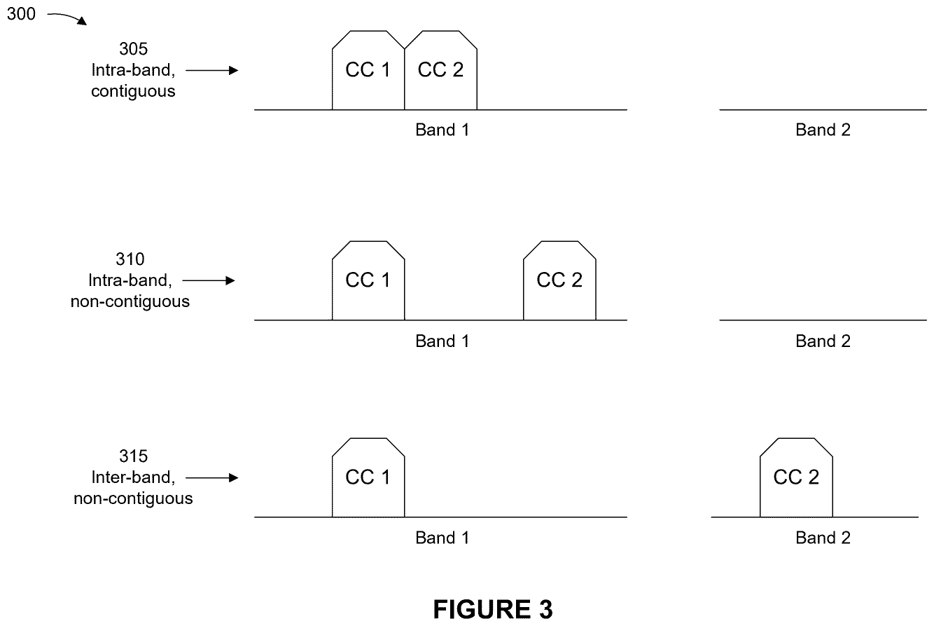

FIG. 3 is a diagram illustrating examples 300 of carrier aggregation.

Carrier aggregation is a technology that enables two or more component carriers (CCs, sometimes referred to as carriers) to be combined (for example, into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, DCI, or another signaling message.

In a first example 305, carrier aggregation may be configured in an intra-band contiguous mode where the aggregated carriers are contiguous to one another and are in the same band. In a second example 310, carrier aggregation may be configured in an intra-band non-contiguous mode where the aggregated carriers are non-contiguous to one another and are in the same band. In a third example 315, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). The primary carrier may carry control information (for example, DCI or scheduling information) for scheduling data communications on one or more secondary carriers or SCells, which may be referred to as cross-carrier scheduling. In some examples, a carrier (for example, a primary carrier or a secondary carrier) may carry control information for scheduling data communications on the carrier, which may be referred to as self-carrier scheduling or carrier self-scheduling.

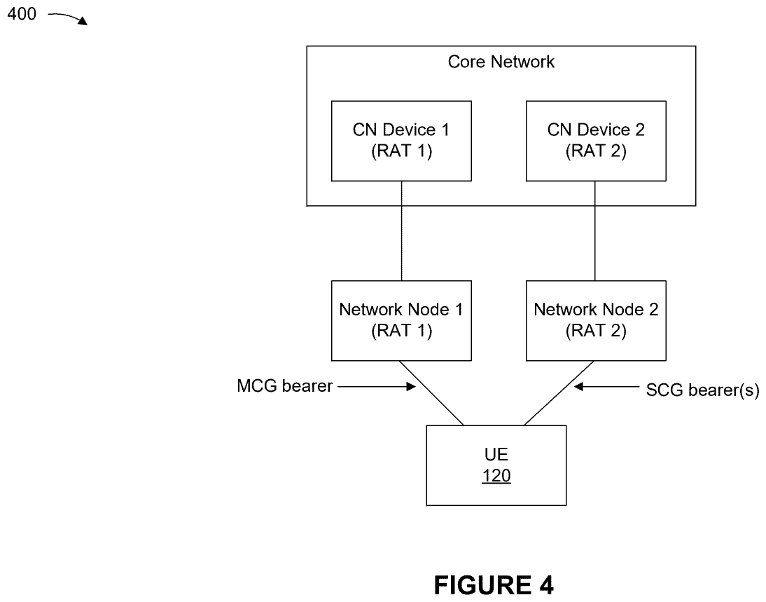

FIG. 4 is a diagram illustrating an example 400 of dual connectivity. The example 400 shown in FIG. 4 may relate to an Evolved Universal Mobile Telecommunications System Terrestrial Radio Access (E-UTRA)-NR dual connectivity (ENDC) mode, a 5G/6G dual connectivity mode, or another suitable mode where a UE 120 communicates using a first RAT and a second RAT. In the dual connectivity mode, a UE 120 communicates using a first RAT on a master cell group (MCG), and the UE 120 communicates using a second RAT on a secondary cell group (SCG). For example, some aspects described herein may apply to an ENDC mode (for example, where the MCG is associated with an LTE RAT and the SCG is associated with an NR RAT), an NR-E-UTRA dual connectivity (NEDC) mode (for example, where the MCG is associated with an NR RAT and the SCG is associated with an LTE RAT), an NR dual connectivity (NRDC) mode (for example, where the MCG is associated with an NR RAT and the SCG is also associated with the NR RAT), a 5G/6G dual connectivity mode (for example, where the MCG is associated with a 5G RAT and the SCG is associated with a 6G RAT), or another dual connectivity mode (for example, where communication via the MCG uses a first RAT and communication via the SCG uses the first RAT or a second RAT).

As shown in FIG. 4, a UE 120 may communicate with both a first network 110 (for example, a 5G network node 110) using a first RAT and a second network node 110 (for example, a 6G network node 110) using a second RAT, and the first network node 110 and the second network node 110 may communicate (for example, directly or indirectly) with a core network that includes one or more core network devices. In some examples, the first network node 110 and the second network node 110 may be co-located at the same network node 110. In some other examples, the first network node 110 and the second network node 110 may be included in different network nodes 110 (for example, may not be co-located).

As further shown in FIG. 4, a wireless network that permits operation in a dual connectivity mode may permit such operations using an MCG for a first RAT (for example, a 4G RAT or a 5G RAT) and an SCG for a second RAT (for example, a 5G RAT or a 6G RAT). In this case, the UE 120 may communicate with the first network node 110 via the MCG, and may communicate with the second network node 110 via the SCG. In some aspects, the MCG may anchor a network connection between the UE 120 and the core network (for example, for mobility, coverage, or control plane information), and the SCG may be added as additional carriers to increase throughput (for example, for data traffic or user plane information). In some aspects, the first network node 110 and the second network node 110 may not transfer user plane information between one another. In some aspects, a UE 120 operating in a dual connectivity mode may be concurrently connected with the first network node 110 and the second network node 110 (for example, in the case of ENDC or NEDC), or may be concurrently connected with one or more network nodes 110 that use the same RAT (for example, in the case of NRDC). In some aspects, the MCG may be associated with a first frequency band (for example, a sub-6 GHz band or an FR1 band, such as a 3.5 GHz band) and the SCG may be associated with a second frequency band (for example, a millimeter wave band or an FR2 band, or another sub-6 GHz band or an FR1 band, such as a 6-8 GHz band).

The UE 120 may communicate via the MCG and the SCG using one or more radio bearers (for example, data radio bearers (DRBs) or signaling radio bearers (SRBs)). For example, the UE 120 may transmit or receive data via the MCG or the SCG using one or more DRBs. Similarly, the UE 120 may transmit or receive control information (for example, RRC information or measurement reports) using one or more SRBs. In some aspects, a radio bearer may be dedicated to a specific cell group (for example, a radio bearer may be an MCG bearer or an SCG bearer). In some aspects, a radio bearer may be a split radio bearer. A split radio bearer may be split in the uplink or in the downlink. For example, a DRB may be split on the downlink (for example, the UE 120 may receive downlink information for the MCG or the SCG in the DRB) but not on the uplink (for example, the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. In cases where the uplink transmit buffer satisfies the uplink data split threshold, the UE 120 may transmit data to the MCG or the SCG using the DRB.

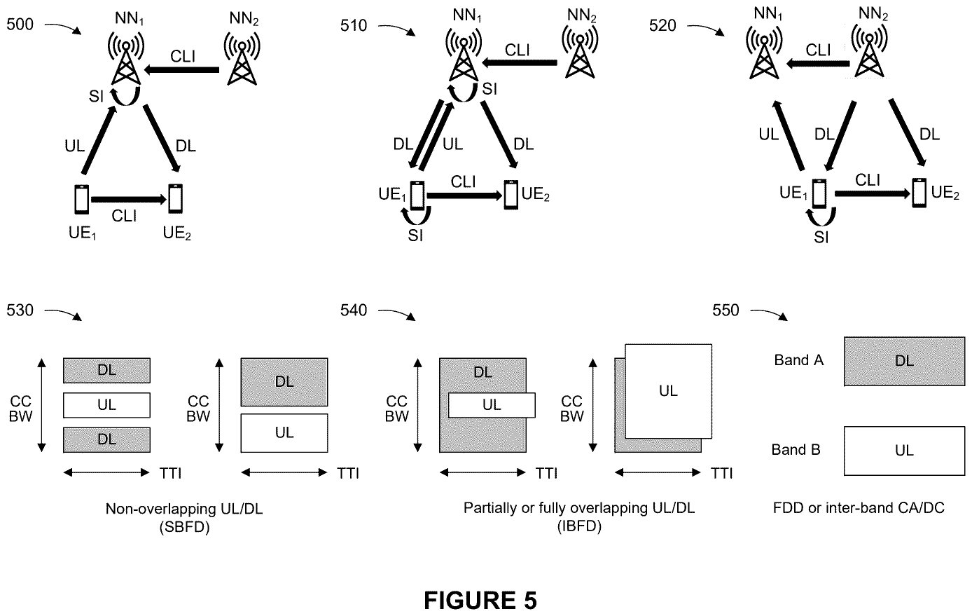

FIG. 5 is a diagram illustrating examples 500, 510, 520 of full-duplex deployment scenarios. As shown in FIG. 5, examples 500, 510, 520 include one or more UEs 120 in communication with one or more network nodes 100 in a wireless network that supports full-duplex communication. In general, as described herein, utilizing a full-duplexing communication mode may provide reduced latency by allowing a downlink transmission to occur in an uplink-only symbol or slot or by allowing an uplink transmission to occur in a downlink-only or flexible symbol or slot. In addition, full-duplex communication may increase an uplink duty cycle, which may improve uplink coverage, may enhance spectral efficiency or throughput per cell or per UE, may increase system capacity, may enable more efficient resource utilization by simultaneously utilizing time and frequency resources for downlink and uplink communication, or may enable flexible and dynamic uplink and downlink resource adaptation according to uplink or downlink traffic patterns. However, as described in further detail herein, full-duplexing communication modes may be associated with dynamic interference conditions.

For example, as shown in FIG. 5, example 500 includes a first UE 120 (shown as UE₁) and a second UE 120 (shown as UE₂) in communication with a first network node 110 (shown as NN₁) operating in a full-duplexing mode, with the first UE 120 and the second UE 120 operating in a half-duplexing mode. For example, as shown in FIG. 5, the first UE 120 may transmit one or more uplink transmissions to the first network node 110, and the second UE 120 may concurrently receive one or more downlink transmissions from the first network node 110. Accordingly, in example 500, the first network node 110 is operating in a full-duplexing mode, and the first UE 120 and the second UE 120 are each operating in a half-duplexing mode. As shown by example 500, there may be various forms of interference that may degrade downlink reception performance at one or more UEs 120 or uplink reception performance at the first network node 110 operating in the full-duplexing mode. For example, as shown, the first network node 110 may experience cross-link interference (CLI) caused by downlink transmissions from a second network node 110 (shown as NN₂) that may be located in an adjacent or nearby cell. Furthermore, as shown, the uplink transmission from the first UE 120 to the first network node may cause CLI at the second UE 120 (for example, CLI that interferes with downlink reception at the second UE 120). Furthermore, as shown, the first network node 110 may experience self-interference, where the downlink transmission to the second UE 120 interferes with reception of the uplink transmission from the first UE 120. For example, as described herein, self-interference may generally occur when a transmitted signal leaks into a receive port or when an object in a surrounding environment reflects a transmitted signal back to a receive port (for example, causing a clutter echo effect), thus interfering with reception of a desired signal at the receive port. In general, the full-duplexing mode used by the first network node 110 in example 500 may be an SBFD mode 530, where a component carrier bandwidth is divided into an uplink sub-band and one or more downlink sub-bands that are separated by one or more guard bands. Additionally, or alternatively, the full-duplexing mode may be an IBFD mode 540, where uplink and downlink resources fully or partially overlap. Additionally, or alternatively, the full-duplexing mode may be an FDD or inter-band carrier aggregation or dual connectivity (CA/DC) mode 550, where uplink and downlink communication is in separate bands.

As further shown in FIG. 5, in example 510, a first UE 120 may communicate with a first network node 110 in a full-duplexing mode. For example, in example 510, the first UE 120 may receive one or more downlink transmissions from the first network node 110, and the first UE 120 may concurrently transmit one or more uplink transmissions to the first network node 110. Accordingly, in example 510, the first network node 110 and the first UE 120 are both operating in a full-duplexing (for example, SBFD, IBFD, FDD, or inter-band CA/DC) mode. Furthermore, as shown, the first network node 110 may be communicating with a second UE 120 operating in a half-duplexing mode. As shown by example 510, the first UE 120 may experience self-interference, where the uplink transmission to the first network node 110 interferes with reception of the downlink transmission from the first network node 110, and the first UE 120 may cause CLI at the second UE 120, where the uplink transmission to the first network node 110 interferes with downlink reception at the second UE 120. Additionally, in example 510, the first network node 110 may experience CLI caused by one or more downlink transmissions from a second network node 110 interfering with reception of the uplink transmission from the first UE 120, and the first network node 110 may experience self-interference, where downlink transmission(s) to the first UE 120 or the second UE 120 interferes with reception of the uplink transmission from the first UE 120. In example 510, the full-duplex communication may be performed in the SBFD mode 530, the IBFD mode 540, or the FDD or inter-band CA/DC mode 550.

As further shown in FIG. 5, in example 520, a first UE 120 may communicate with a first network node 110 and a second network node 110 in a full-duplexing mode (for example, a multi-TRP mode). For example, in example 520, the first UE 120 may transmit one or more uplink transmissions to the first network node 110 (for example, a first TRP), and the first UE 120 may concurrently receive one or more downlink transmissions from the second network node 110 (for example, a second TRP). Accordingly, in example 520, the first UE 120 is operating in a full-duplexing mode, and the first and second network nodes 110 are both operating in a half-duplexing mode. As shown by example 520, the first UE 120 may experience self-interference, where the uplink transmission to the first network node 110 interferes with reception of the downlink transmission from the second network node 110. Furthermore, the uplink transmission by the first UE 120 may cause CLI at a second UE 120 receiving a downlink transmission from the second network node 110. Furthermore, as shown, the downlink transmission by the second network node 110 may cause CLI that interferes with uplink reception at the first network node 110. In example 520, the full-duplex communication may be performed in the SBFD mode 530, the IBFD mode 540, or the FDD or inter-band CA/DC mode 550.

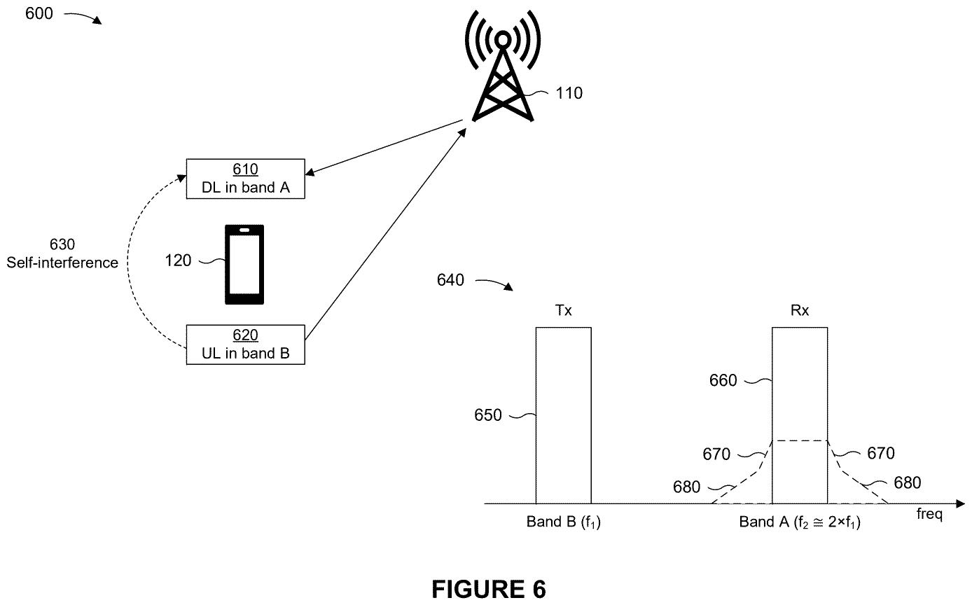

FIG. 6 is a diagram illustrating an example 600 of self-interference in an inter-band full-duplex deployment scenario. As shown in FIG. 6, example 600 includes communication between a network node 110 and a UE 120. In some aspects, the network node 110 and the UE 120 may communicate in a wireless network, such as wireless network 100 via a wireless access link that includes an uplink and a downlink.

As described herein, full-duplex communication that permits simultaneous transmission and reception may be enabled in one or more modes where uplink transmission and downlink reception are in different frequency bands. For example, the UE 120 may simultaneously transmit an uplink transmission to the network node 110 and receive a downlink transmission from the network node 110 in an FDD mode, where simultaneous transmission and reception occurs in paired spectrum using non-overlapping downlink-only and uplink-only frequency bands that are separated by a guard band. Additionally or alternatively, simultaneous transmission and reception in separate frequency bands may be enabled in an inter-band carrier aggregation or dual connectivity configuration, where the network node 110 provides the UE 120 with an uplink resource allocation spanning a first set of frequencies in a first frequency band (shown as band B in FIG. 6) and a downlink resource allocation spanning a second set of frequencies in a second frequency band (shown as band A in FIG. 6). Accordingly, simultaneous transmission in the first frequency band and reception in the second frequency band may be enabled in one or more time intervals (for example, when a TDD pattern of the first frequency band includes uplink symbols, slots, or other intervals that overlap with downlink symbols, slots, or other intervals in a TDD pattern of the second frequency band, or vice versa).

Although inter-band carrier aggregation and inter-band dual connectivity may reduce latency, enhance spectral efficiency or throughput, or increase resource utilization efficiency because time and frequency resources can be simultaneously utilized for uplink and downlink communication or exploit different RATs, inter-band carrier aggregation and inter-band dual connectivity present various challenges, including self-interference caused by concurrent transmission and reception. For example, self-interference generally occurs when energy from one or more transmit circuits leaks into one or more receive circuits, or when clutter echo causes transmitted signal energy to enter one or more receive circuits after reflecting off one or more objects in a surrounding environment. Full-duplex devices therefore often implement one or more techniques to measure and cancel the self-interference or to otherwise mitigate the self-interference. For example, in full-duplexing modes where downlink and uplink communication occur in separate frequency bands (for example, an FDD mode, an inter-band carrier aggregation mode, or an inter-band dual connectivity mode), a UE 120 may implement an RF front-end to mitigate interference from a worst case jammer (for example, a signal causing the most interference). Accordingly, because the transmission by the UE 120 can cause a jamming condition at the receiver, the UE 120 may backoff (for example, reduce) an ADC setpoint or an AFE setpoint according to an assumption that the transmitter is always transmitting.

However, in some cases, inter-band carrier aggregation or dual connectivity may be configured using specific band combinations that can result in relatively high self-interference, despite typical mitigation techniques. For example, an inter-band carrier aggregation or dual connectivity configuration may combine a first band with a second band that includes one or more harmonic frequencies of fundamental frequencies in the first band, which may result in transmissions at the fundamental frequencies causing IMD that interferes with reception at the harmonic frequencies. For example, an inter-band carrier aggregation or dual connectivity configuration may combine the 3.5 GHz C-band often used for 5G communication with the 7 GHz band that offers higher capacity and data rates suitable to support advanced technologies used in 6G communication. In such cases, as shown in FIG. 6, a UE 120 may receive one or more downlink transmissions 610 in the higher frequency band (for example, the 7 GHz band) and concurrently transmit one or more uplink transmissions 620 in the lower frequency band (for example, the 3.5 GHz band), and the uplink transmissions 620 in the lower frequency band may cause self-interference 630 with respect to downlink reception in the higher frequency band. More particularly, given a fundamental frequency, f₁, harmonic frequencies are integer multiples of the fundamental frequency, such as [2, 3, 4, . . . ]×f₁, where a signal at the fundamental frequency can generate second harmonics that cause distortion at the harmonic frequencies.

Accordingly, as described herein, second harmonics generally indicate where distortion falls, given an original signal at a fundamental frequency. For example, the signal at the fundamental frequency can cause second order distortion (IMD2) and fourth order distortion (IMD4) that both fall on the second harmonics. For example, referring to example 640, an uplink transmission at a fundamental frequency, f₁, in a first frequency band is associated with signal energy 650, which may be expressed as re(x·e^{j·2·π·f}^{₁}), and a downlink transmission at a harmonic frequency, f₂≅2·f₁, in a second frequency band is associated with signal energy 660, which may be expressed as re(x·e^{j·2·π·f}^{₂}). However, the uplink transmission can cause non-uniform IMD that interferes with downlink reception at the harmonic frequency, which is shown by the dashed line in example 640. For example, given an uplink transmission that allocates N RBs at the fundamental frequency f₁, the uplink transmission will cause second order distortion that leaks 2N RBs at the harmonic frequency f₂≅2·f₁, including distortion that is relatively even at the center N RBs and reduced toward the edges of the 2N RBs, as shown by reference number 670. In addition, the uplink transmission will cause fourth order distortion that leaks 4N RBs at the harmonic frequency f₂≅2·f₁, where the fourth order distortion is reduced relative to the second order distortion, as shown by reference number 680. The uplink transmission at the fundamental frequency therefore causes non-uniform leakage, and therefore non-uniform self-interference with reception at the harmonic frequency. Accordingly, in inter-band carrier aggregation or dual connectivity configurations, self-interference can occur due to second harmonics despite the separation between downlink and uplink frequency resources. Furthermore, mitigating the self-interference in an inter-band carrier aggregation or dual connectivity configuration poses challenges due to non-uniform leakage or interference from the uplink frequency resources to the downlink frequency resources. For example, uplink transmission at certain frequencies may not have a self-interference impact when downlink resources are not harmonic frequencies of the transmission frequencies.

Various aspects relate generally to communication configurations to mitigate inter-band self-interference when an uplink resource allocation in a first frequency band includes one or more fundamental frequencies and a downlink resource allocation in a second frequency band includes one or more harmonic frequencies of the one or more fundamental frequencies. Some aspects more specifically relate to a network node 110 providing a UE 120 with one or more communication configurations that include a first set of communication parameters for time intervals with a potential self-interference impact and a second set of communication parameters for time intervals without a potential self-interference impact. For example, in some aspects, the one or more communication configurations may include a downlink SPS configuration or an uplink CG configuration. Accordingly, in a given SPS or CG transmission occasion, the UE 120 may apply either the first set of communication parameters or the second set of communication parameters depending on the self-interference impact in a time interval that includes the SPS or CG transmission occasion (for example, according to an implicit determination by the UE 120 as to whether a symbol or slot includes an uplink transmission and an impacted downlink reception, or an explicit indication received from the network node 110). In some aspects, the communication parameters for the time intervals with the potential self-interference impact may be configured as offsets relative to the communication parameters for the time intervals with the potential self-interference impact. Furthermore, in some aspects, a dynamically scheduled transmission may include a scheduling offset that is sufficiently large to allow the UE 120 to decode the dynamic grant and change parameters as-needed before the transmission occurs. In addition, in CG transmission occasions where the UE 120 does not have uplink data to transmit, the UE 120 may transmit a CG skipping indication to the network node 110 and apply the parameters for the time intervals without a self-interference impact, or the network node 110 may adjust downlink scheduling according to the CG skipping indication.

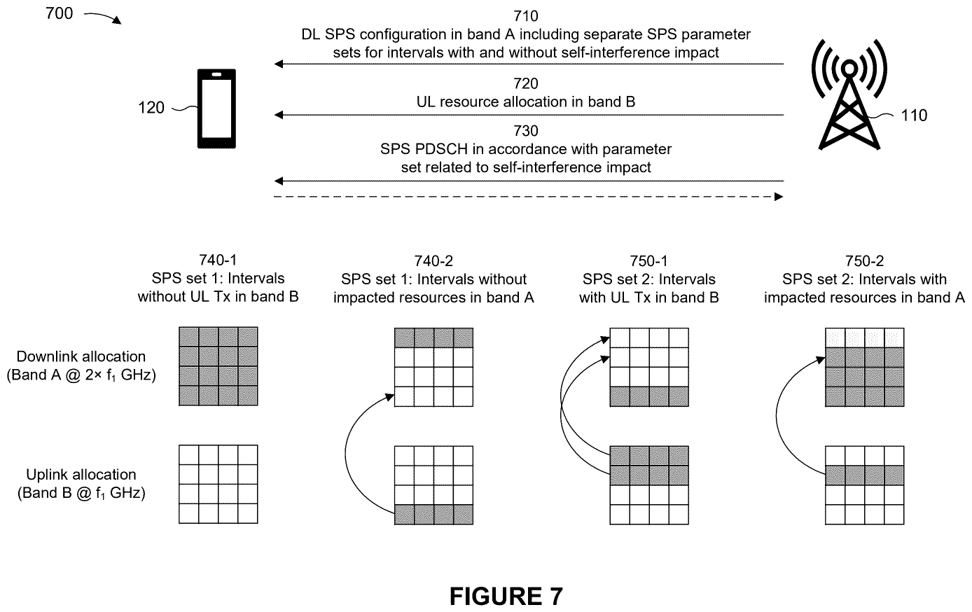

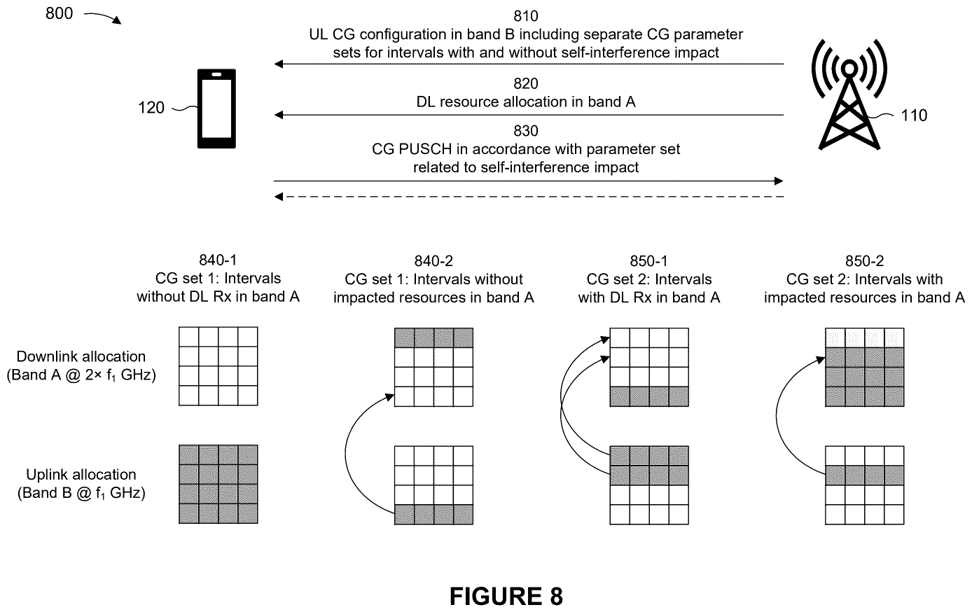

FIG. 7 is a diagram illustrating an example 700 related to a downlink SPS configuration to mitigate inter-band self-interference. As shown in FIG. 7, example 700 includes communication between a network node 110 and a UE 120. In some aspects, the network node 110 and the UE 120 may communicate in a wireless network, such as wireless network 100 via a wireless access link that includes an uplink and a downlink. In some aspects, example 700 may be implemented in combination with example 800 depicted in FIG. 8, which is related to an uplink CG configuration to mitigate inter-band self-interference. In some aspects, as described herein, one or more operations of example 700 may be performed in accordance with the UE 120 transmitting, and the network node 110 receiving, a capability message or capability signaling indicating that the UE 120 has a capability to support an inter-band carrier aggregation or dual connectivity mode and to apply different sets of SPS parameters in different time intervals in accordance with a potential self-interference impact.

In some aspects, in a first operation 710, the network node 110 may transmit, and the UE 120 may receive, information indicating a downlink resource allocation in a first frequency band, which may also be referred to herein as band A. In some aspects, as described herein, the downlink resource allocation includes resources related to a downlink SPS configuration, such as resources in a time domain, a frequency domain, a spatial domain, or a code domain, which recur according to a periodicity to define periodically reoccurring (for example, configured) SPS occasions in which the UE 120 may receive an SPS PDSCH transmission from the network node 110.

In some aspects, as shown in FIG. 7, the downlink SPS configuration may indicate separate sets of SPS parameters for time intervals (for example, symbols, slots, frames, or other intervals) with a potential self-interference impact and time intervals without a potential self-interference impact. For example, when the UE 120 receives an SPS PDSCH transmission from the network node 110 in an SPS occasion, the SPS PDSCH transmission is generally associated with (for example, configured, transmitted, or demodulated and decoded according to) various parameters, such as a frequency domain resource assignment (for example, an RB allocation), a time domain resource assignment (for example, a start and length indicator value), an MCS, a HARQ process number, a PUCCH resource indicator, or a PDSCH-to-HARQ feedback timing value (for example, a K1 value defining an offset from the SPS occasion to a PUCCH resource carrying HARQ feedback for the SPS PDSCH transmission in the SPS occasion). In some cases, however, such as when inter-band carrier aggregation or dual connectivity is configured for the UE 120, the UE 120 may receive an uplink resource allocation in a second frequency band, which may also be referred to herein as band B, and uplink transmission(s) in band B may cause self-interference when there is simultaneous downlink reception (for example, an SPS occasion) in band A due to second harmonics. In particular, as described herein, the self-interference may occur on one or more impacted downlink frequency resources or RBs in band A, which include harmonic frequencies of fundamental uplink frequencies in band B, such as frequency resources or RBs in band A that are integer multiples of (for example, two times) frequency resources or RBs in band B.

Accordingly, as described herein, the downlink SPS configuration in band A generally includes a downlink resource allocation spanning a set of frequencies in band A, with the set of frequencies including one or more harmonic frequencies that are potentially impacted by self-interference from one or more fundamental frequencies in another band where uplink communication may be configured or scheduled for the UE 120. In some aspects, to mitigate potential self-interference caused by concurrent uplink transmission via the one or more fundamental frequencies and downlink reception via the one or more harmonic frequencies, the downlink SPS configuration may include or indicate separate sets of SPS parameters for time intervals with a potential self-interference impact and time intervals without a potential self-interference impact. For example, in some aspects, the downlink SPS configuration may include a first set of SPS parameters (such as a first RB allocation, a first start and length indicator value (SLIV), a first MCS, a first power value, or a first set of spatial parameters, among other examples) applicable to time intervals where there is no uplink transmission configured or scheduled in band B or time intervals where there are no downlink frequency resources or RBs in band A that are impacted by an uplink transmission configured or scheduled in band B. In addition, the downlink SPS configuration may include a second set of SPS parameters (such as a second RB allocation, a second SLIV, a second MCS, a second power value, or a second set of spatial parameters, among other examples) applicable to time intervals where there is an uplink transmission configured or scheduled in band B or time intervals where there are downlink frequency resources or RBs in band A that are impacted by an uplink transmission configured or scheduled in band B.

In some aspects, at least one value in the first set of SPS parameters is different from a corresponding value in the second set of SPS parameters. For example, the first set of SPS parameters and the second set of SPS parameters may have different spatial parameters, to reflect that different downlink beams may experience different levels of self-interference from concurrent uplink transmissions at a harmonic frequency. In another example, the first set of SPS parameters and the second set of SPS parameters may have different RB allocations, such that SPS transmissions in time intervals with a potential self-interference impact do not use frequencies or RBs in band A that are harmonic frequencies of fundamental frequencies or RBs in band B. In another example, the first set of SPS parameters and the second set of SPS parameters may have different MCS values, such that SPS transmissions in time intervals with a potential self-interference impact use a lower MCS value to improve demodulation and decoding performance and SPS transmissions in time intervals without a potential self-interference impact use a higher MCS value to improve throughput. In some aspects, the first set of SPS parameters and the second set of SPS parameters may include one or more parameters with identical values (for example, the same PDSCH-to-HARQ feedback timing values, because a PUCCH transmission in band A is not subject to self-interference from a concurrent uplink transmission in band B). Furthermore, in some aspects, the second set of SPS parameters applicable to time intervals with a potential self-interference impact may be indicated according to offset values relative to the first set of SPS parameters applicable to time intervals without a potential self-interference impact (for example, an RB offset, a power offset, or another suitable offset), which may reduce signaling overhead (for example, a quantity of bits) to indicate the separate sets of SPS parameters for time intervals with and without a self-interference impact.

As further shown in FIG. 7, in a second operation 720, the network node 110 may transmit, and the UE 120 may receive, information that indicates an uplink resource allocation that spans a set of frequencies in band B. In some aspects, the uplink resource allocation may relate to an uplink CG configuration that includes periodic CG occasions associated with certain time and frequency resources and other suitable parameters, as described in more detail above with respect to FIG. 2 or below with respect to FIG. 8. In such examples, the time resources occupied by the periodic CG occasions are known to the UE 120 and the network node 110 in advance, such that the UE 120 or the network node 110 can determine whether a CG transmission is scheduled or configured in a time interval that includes an SPS transmission occasion. Furthermore, the frequency resources occupied by the periodic CG occasions are known to the UE 120 and the network node 110 in advance, such that the UE 120 or the network node 110 can determine whether a scheduled or configured CG transmission uses frequency resources in band B that impact harmonic frequencies included in the downlink resource allocation for receiving an SPS transmission in band A.

Additionally or alternatively, in cases where the UE 120 does not have any buffered uplink data to transmit in a CG occasion, the UE 120 may transmit, and the network node 110 may receive, an uplink CG skipping indication, which indicates that the UE 120 will skip (for example, not transmit a CG PUSCH in) the CG occasion. In such examples, and in accordance with the uplink CG skipping indication, the UE 120 and the network node 110 may know in advance that a CG transmission will not occur in a particular CG occasion that may or may not overlap with a time interval that includes an SPS transmission occasion.

Additionally or alternatively, the uplink resource allocation may relate to a dynamically scheduled PUSCH transmission. For example, the uplink resource allocation may be indicated in DCI that includes an uplink grant indicating a frequency domain resource assignment (for example, an RB allocation), a time domain resource assignment, a frequency hopping flag, an MCS, or other suitable parameters for a dynamically scheduled PUSCH. In addition, the uplink grant may include a scheduling offset, or K2 value, that indicates a quantity of symbols or slots from a symbol or slot where the uplink grant is received to a first symbol or slot of the dynamically scheduled PUSCH. For example, in some aspects, the scheduling offset or K2 value is generally related to the time that the UE 120 takes to decode the DCI and prepare transmission circuits to perform the dynamically scheduled PUSCH. In addition, because the dynamically scheduled PUSCH may occur in a time interval that overlaps with an SPS transmission occasion, or may occupy frequency resources in band B that impact harmonic frequencies in band A that are included in a downlink resource allocation for a scheduled or configured SPS transmission, the uplink grant may influence the SPS parameter set to be applied in an SPS transmission occasion. Accordingly, the scheduling offset (for example, K2 value) in the uplink grant may be selected from a set of candidate values that satisfy (for example, equal or exceed) a threshold, or are otherwise sufficiently large, to allow the UE 120 to decode the uplink grant and adjust SPS transmission parameters prior to the dynamically scheduled PUSCH that may potentially cause self-interference for an upcoming SPS transmission occasion.

As further shown in FIG. 7, in a third operation 730, the UE 120 may communicate with the network node 110 in a time interval that includes an SPS transmission occasion in accordance with an uplink resource allocation during the time interval. For example, as described herein, the UE 120 may apply the first set of SPS parameters or the second set of SPS parameters to receive an SPS PDSCH transmission in the SPS transmission occasion in band A in accordance with an uplink resource allocation in band B during a time interval that includes the SPS transmission occasion. For example, in some aspects, the UE 120 may implicitly determine whether there is a self-interference impact in accordance with a time and frequency resource allocation for an uplink CG transmission occasion, in accordance with an uplink CG skipping indication, or a time and frequency resource allocation for a dynamically scheduled PUSCH transmission. Alternatively, in some aspects, the network node 110 may transmit, and the UE 120 may receive, signaling that indicates whether the UE 120 is to apply the first set of SPS parameters or the second set of SPS parameters to receive the SPS PDSCH transmission in band A in a particular SPS transmission occasion (for example, in accordance with an uplink CG configuration, an uplink CG skipping indication, or an uplink grant dynamically scheduling a PUSCH transmission). Additionally, or alternatively, the signaling may include a bitmap that indicates the set of SPS parameters to apply in each SPS occasion in a set of SPS occasions (for example, the bitmap may have a structure where “0” indicates the first set of SPS parameters and “1” indicates the second set of SPS parameters, such that the bitmap “0011” indicates that the UE 120 is to use the first set of SPS parameters in the next two SPS occasions, and the second set of SPS parameters in the next two SPS occasions).

For example, FIG. 7 illustrates a first example 740-1, where the UE 120 communicates with the network node 110 (for example, receives the SPS PDSCH transmission) using the first set of SPS parameters in accordance with no uplink transmission being scheduled or configured in band B during a time interval that includes the SPS transmission occasion. Alternatively, in a second example 740-2, the UE 120 may communicate with the network node 110 (for example, receives the SPS PDSCH transmission) using the first set of SPS parameters in accordance with an uplink transmission being scheduled or configured in band B on frequency resources or RBs that do not impact frequency resources or RBs used for the SPS transmission in band A (for example, the uplink transmission in band B uses a first frequency f₁ and the SPS transmission in band A uses a second frequency f₂≠2×f₁, such that the uplink transmission does not have a self-interference impact on the SPS PDSCH transmission.

Additionally, or alternatively, FIG. 7 illustrates a first example 750-1, where the UE 120 communicates with the network node 110 (for example, receives the SPS PDSCH transmission) using the second set of SPS parameters in accordance with an uplink transmission being scheduled or configured in band B during a time interval that includes the SPS transmission occasion in band A. In the first example 750-1, the UE 120 uses the second set of SPS parameters to receive the SPS PDSCH transmission regardless of whether the uplink transmission in band B uses frequency resources or RBs that have harmonic frequencies in the frequency resource or RB allocation of the concurrent SPS transmission. Alternatively, in a second example 750-2, the UE 120 may communicate with the network node 110 (for example, receive the SPS PDSCH transmission) using the second set of SPS parameters in accordance with an uplink transmission being scheduled or configured in band B on frequency resources or RBs that impact frequency resources or RBs used for the SPS transmission in band A (for example, the uplink transmission in band B uses a first frequency f₁ and the SPS transmission in band A uses a second frequency f₂=2×f₁, such that the uplink transmission has a self-interference impact on the SPS PDSCH transmission).

FIG. 8 is a diagram illustrating an example 800 related to an uplink CG configuration to mitigate inter-band self-interference. As shown in FIG. 8, example 800 includes communication between a network node 110 and a UE 120. In some aspects, the network node 110 and the UE 120 may communicate in a wireless network, such as wireless network 100 via a wireless access link that includes an uplink and a downlink. In some aspects, example 800 may be implemented in combination with example 700 depicted in FIG. 7, which is related to a downlink SPS configuration to mitigate inter-band self-interference. In some aspects, as described herein, one or more operations of example 800 may be performed in accordance with the UE 120 transmitting, and the network node 110 receiving, a capability message or capability signaling indicating that the UE 120 has a capability to support an inter-band carrier aggregation or dual connectivity mode and to apply different sets of CG parameters in different time intervals in accordance with a potential self-interference impact.

In some aspects, in a first operation 810, the network node 110 may transmit, and the UE 120 may receive, information indicating an uplink resource allocation in a first frequency band, which may also be referred to herein as band B. In some aspects, as described herein, the uplink resource allocation includes resources related to an uplink CG configuration, such as resources in a time domain, a frequency domain, a spatial domain, or a code domain, which recur according to a periodicity to define periodically reoccurring (for example, configured) CG occasions in which the UE 120 may transmit a CG PUSCH to the network node 110.

In some aspects, as shown in FIG. 8, the uplink CG configuration may indicate separate sets of CG parameters for time intervals (for example, symbols, slots, frames, or other intervals) with a potential self-interference impact and time intervals without a potential self-interference impact. For example, when the UE 120 transmits a CG PUSCH to the network node 110 in a CG occasion, the CG PUSCH transmission is generally associated with (for example, configured or transmitted by the UE 120, or demodulated and decoded by the network node 110 according to) various parameters, such as a frequency domain resource assignment (for example, an RB allocation), a time domain resource assignment, an MCS, a HARQ process number, or uplink power control parameters, among other examples. In some cases, however, such as when inter-band carrier aggregation or dual connectivity is configured for the UE 120, the UE 120 may receive a downlink resource allocation in a second frequency band, which may also be referred to herein as band A, and uplink (for example, CG PUSCH) transmission(s) in band B may cause self-interference when there is simultaneous downlink reception (for example, an SPS occasion or dynamically scheduled PDSCH) in band A due to second harmonics. In particular, as described herein, the self-interference may occur on one or more impacted downlink frequency resources or RBs in band A, which include harmonic frequencies of fundamental uplink frequencies in band B, such as frequency resources or RBs in band A that are integer multiples of (for example, two times) frequency resources or RBs in band B.

Accordingly, as described herein, the uplink CG configuration in band B generally includes an uplink resource allocation spanning a set of frequencies in band B, with the set of frequencies in band A including one or more harmonic frequencies that are potentially impacted by self-interference from one or more fundamental frequencies in band B where uplink communication may be configured or scheduled for the UE 120. In some aspects, to mitigate potential self-interference caused by concurrent uplink transmission via the one or more fundamental frequencies and downlink reception via the one or more harmonic frequencies, the uplink CG configuration may include or indicate separate sets of CG parameters for time intervals with a potential self-interference impact and time intervals without a potential self-interference impact. For example, in some aspects, the uplink CG configuration may include a first set of CG parameters (such as a first RB allocation, a first MCS, a first uplink control power value, or a first set of spatial parameters, among other examples) applicable to time intervals where there is no downlink reception configured or scheduled in band A or time intervals where there are no downlink frequency resources or RBs in band A that are impacted by an uplink transmission configured or scheduled in band B. In addition, the uplink CG configuration may include a second set of CG parameters (such as a second RB allocation, a second MCS, a second uplink power control value, or a second set of spatial parameters, among other examples) applicable to time intervals where there is a downlink transmission configured or scheduled in band A or time intervals where there are downlink frequency resources or RBs in band A that are impacted by an uplink transmission configured or scheduled in band B.

In some aspects, at least one value in the first set of CG parameters is different from a corresponding value in the second set of CG parameters. For example, the first set of CG parameters and the second set of CG parameters may have different spatial parameters, to reflect that different uplink beams may cause different levels of self-interference with concurrent downlink receptions at a harmonic frequency. In another example, the first set of CG parameters and the second set of CG parameters may have different RB allocations, such that CG transmissions in time intervals with a potential self-interference impact do not use frequencies or RBs in band B that have harmonic frequencies in the downlink resource allocation of band B. In some aspects, the first set of CG parameters and the second set of CG parameters may include one or more parameters with identical values (for example, parameters that do not increase or decrease the self-interference on a concurrent downlink reception in band A). Furthermore, in some aspects, the second set of CG parameters applicable to time intervals with a potential self-interference impact may be indicated according to offset values relative to the first set of CG parameters applicable to time intervals without a potential self-interference impact (for example, an RB offset, a power control offset, or another suitable offset), which may reduce signaling overhead (for example, a quantity of bits) to indicate the separate sets of CG parameters for time intervals with and without a self-interference impact.

As further shown in FIG. 8, in a second operation 820, the network node 110 may transmit, and the UE 120 may receive, information that indicates a downlink resource allocation that spans a set of frequencies in band A. In some aspects, the downlink resource allocation may relate to a downlink SPS configuration that includes periodic SPS occasions associated with certain time and frequency resources and other suitable parameters, as described in more detail above with respect to FIG. 2 or FIG. 7. In such examples, the time resources occupied by the periodic SPS occasions are known to the UE 120 and the network node 110 in advance, such that the UE 120 or the network node 110 can determine whether SPS reception is scheduled or configured in a time interval that includes a CG transmission occasion. Furthermore, the frequency resources occupied by the periodic SPS occasions are known to the UE 120 and the network node 110 in advance, such that the UE 120 or the network node 110 can determine whether a scheduled or configured SPS transmission uses frequency resources in band A that include harmonic frequencies impacted by frequencies included in the uplink resource allocation for a CG transmission in band B.

Additionally or alternatively, the downlink resource allocation may relate to a dynamically scheduled PDSCH transmission. For example, the downlink resource allocation may be indicated in DCI that includes a downlink grant indicating a frequency domain resource assignment (for example, an RB allocation), a time domain resource assignment, an MCS, or other suitable parameters for a dynamically scheduled PDSCH. In addition, the downlink grant may include a scheduling offset, or K0 value, that indicates a quantity of symbols or slots from a symbol or slot where the downlink grant is received to a first symbol or slot of the dynamically scheduled PDSCH. For example, in some aspects, the scheduling offset or K0 value is generally related to the time that the UE 120 takes to decode the DCI and prepare to receive the dynamically scheduled PDSCH. In addition, because the dynamically scheduled PDSCH may occur in a time interval that overlaps with a CG transmission occasion, or may occupy frequency resources in band A that include harmonic frequencies impacted by fundamental frequencies in band B that are included in an uplink resource allocation for a scheduled or configured CG transmissions, the downlink grant may influence the CG parameter set to be applied in a CG transmission occasion. Accordingly, the scheduling offset (for example, K0 value) in the downlink grant may be selected from a set of candidate values that satisfy (for example, equal or exceed) a threshold, or are otherwise sufficiently large, to allow the UE 120 to decode the downlink grant and adjust CG transmission parameters prior to the dynamically scheduled PDSCH that may potentially experience self-interference during an upcoming CG transmission occasion.

As further shown in FIG. 8, in a third operation 830, the UE 120 may communicate with the network node 110 in a time interval that includes a CG transmission occasion in accordance with a downlink resource allocation during the time interval. For example, as described herein, the UE 120 may apply the first set of CG parameters or the second set of CG parameters to transmit a CG PUSCH in the CG transmission occasion in band B in accordance with a downlink resource allocation in band A during a time interval that includes the CG transmission occasion. For example, in some aspects, the UE 120 may implicitly determine whether there is a self-interference impact in accordance with a time and frequency resource allocation for a downlink SPS transmission occasion, or a time and frequency resource allocation for a dynamically scheduled PDSCH transmission. Alternatively, in some aspects, the network node 110 may transmit, and the UE 120 may receive, signaling that indicates whether the UE 120 is to apply the first set of CG parameters or the second set of CG parameters to transmit the CG PUSCH in band B in a particular CG transmission occasion (for example, in accordance with a downlink SPS configuration or downlink grant dynamically scheduling a PDSCH transmission). Additionally, or alternatively, the signaling may include a bitmap that indicates the set of CG parameters to apply in each CG occasion in a set of CG occasions (for example, the bitmap may have a structure where “0” indicates the first set of CG parameters and “1” indicates the second set of CG parameters, such that the bitmap “0101” indicates that the UE 120 is to alternate between using the first set of CG parameters and the second set of CG parameters over the next four CG occasions).

For example, FIG. 8 illustrates a first example 840-1, where the UE 120 communicates with the network node 110 (for example, transmits the CG PUSCH) using the first set of CG parameters in accordance with no downlink reception being scheduled or configured in band A during a time interval that includes the CG transmission occasion. Alternatively, in a second example 840-2, the UE 120 may communicate with the network node 110 (for example, transmit the CG PUSCH) using the first set of CG parameters in accordance with a downlink transmission being scheduled or configured in band A on frequency resources or RBs that are not impacted by frequency resources or RBs used for the CG transmission in band B (for example, the CG PUSCH transmission in band B uses a first frequency f₁ and the downlink reception in band A is on a second frequency f₂≠2×f₁, such that the CG PUSCH transmission does not have a self-interference impact on the downlink reception).

Additionally, or alternatively, FIG. 8 illustrates a first example 850-1, where the UE 120 communicates with the network node 110 (for example, transmits the CG PUSCH) using the second set of CG parameters in accordance with a downlink transmission being scheduled or configured in band A during a time interval that includes the CG transmission occasion in band B. In the first example 850-1, the UE 120 uses the second set of CG parameters to transmit the CG PUSCH regardless of whether a downlink transmission in band A uses frequency resources or RBs that are harmonic frequencies of fundamental frequencies included in the frequency resource or RB allocation of the concurrent CG PUSCH transmission. Alternatively, in a second example 850-2, the UE 120 may communicate with the network node 110 (for example, transmits the CG PUSCH) using the second set of CG parameters in accordance with a downlink transmission being scheduled or configured in band A on frequency resources or RBs that are impacted by frequency resources or RBs used for the CG PUSCH transmission in band B (for example, the CG PUSCH transmission in band B uses a first frequency f₁ and the downlink reception in band A uses a second frequency f₂=2×f₁, such that the CG PUSCH transmission in band B has a self-interference impact on the concurrent downlink reception in band A due to second harmonics.

FIG. 9 is a flowchart illustrating an example process 900 performed, for example, at a UE or an apparatus of a UE that supports full-duplex communication. Example process 900 is an example where the apparatus or the UE (for example, UE 120) performs operations associated with a communication configuration to mitigate inter-band self-interference.

As shown in FIG. 9, in some aspects, process 900 may include receiving, from a network node, an uplink resource allocation spanning a first set of frequencies in a first frequency band (block 910). For example, the UE (such as by using communication manager 1106 or reception component 1102, depicted in FIG. 11) may receive, from a network node, an uplink resource allocation spanning a first set of frequencies in a first frequency band, as described above.

As further shown in FIG. 9, in some aspects, process 900 may include receiving, from the network node, a downlink resource allocation spanning a second set of frequencies in a second frequency band, wherein the second set of frequencies includes one or more harmonic frequencies impacted by self-interference from one or more fundamental frequencies in the first set of frequencies (block 920). For example, the UE (such as by using communication manager 1106 or reception component 1102, depicted in FIG. 11) may receive, from the network node, a downlink resource allocation spanning a second set of frequencies in a second frequency band, wherein the second set of frequencies includes one or more harmonic frequencies impacted by self-interference from one or more fundamental frequencies in the first set of frequencies, as described above.

As further shown in FIG. 9, in some aspects, process 900 may include receiving, from the network node, information indicating a first set of communication parameters for time intervals with a potential self-interference impact on the one or more harmonic frequencies and a second set of communication parameters for time intervals without the potential self-interference impact on the one or more harmonic frequencies (block 930). For example, the UE (such as by using communication manager 1106 or reception component 1102, depicted in FIG. 11) may receive, from the network node, information indicating a first set of communication parameters for time intervals with a potential self-interference impact on the one or more harmonic frequencies and a second set of communication parameters for time intervals without the potential self-interference impact on the one or more harmonic frequencies, as described above.

As further shown in FIG. 9, in some aspects, process 900 may include communicating with the network node in a transmission occasion using the first set of communication parameters or the second set of communication parameters in accordance with a state of the uplink resource allocation and the downlink resource allocation in a time interval that includes the transmission occasion (block 940). For example, the UE (such as by using communication manager 1106, reception component 1102, or transmission component 1104, depicted in FIG. 11) may communicate with the network node in a transmission occasion using the first set of communication parameters or the second set of communication parameters in accordance with a state of the uplink resource allocation and the downlink resource allocation in a time interval that includes the transmission occasion, as described above.

Process 900 may include additional aspects, such as any single aspect or any combination of aspects described below or in connection with one or more other processes described elsewhere herein.

In a first additional aspect, the one or more harmonic frequencies are impacted by self-interference related to IMD caused by concurrent transmission in the one or more fundamental frequencies and reception in the one or more harmonic frequencies.

In a second additional aspect, alone or in combination with the first aspect, the one or more harmonic frequencies are second harmonics of the one or more fundamental frequencies.

In a third additional aspect, alone or in combination with one or more of the first and second aspects, the first frequency band is in a range from 410 MHz to 7.125 GHz and the second frequency band is in a range from 7.125 GHz to 24.25 GHz.

In a fourth additional aspect, alone or in combination with one or more of the first through third aspects, the uplink resource allocation and the downlink resource allocation are related to inter-band carrier aggregation operation or inter-band dual connectivity operation.

In a fifth additional aspect, alone or in combination with one or more of the first through fourth aspects, the first set of communication parameters and the second set of communication parameters are related to an SPS configuration that is in accordance with the downlink resource allocation.

In a sixth additional aspect, alone or in combination with one or more of the first through fifth aspects, the first set of communication parameters and the second set of communication parameters are related to a CG configuration that is in accordance with the uplink resource allocation.

In a seventh additional aspect, alone or in combination with one or more of the first through sixth aspects, communicating in the transmission occasion includes communicating in the transmission occasion using the first set of communication parameters in accordance with the time interval including the transmission occasion having an uplink transmission in the first frequency band or concurrent uplink transmission in the one or more fundamental frequencies and downlink reception in the one or more harmonic frequencies.

In an eighth additional aspect, alone or in combination with one or more of the first through seventh aspects, communicating in the transmission occasion includes communicating in the transmission occasion using the second set of communication parameters in accordance with the time interval including the transmission occasion not having an uplink transmission in the first frequency band or not having concurrent uplink transmission in the one or more fundamental frequencies and downlink reception in the one or more harmonic frequencies.

In a ninth additional aspect, alone or in combination with one or more of the first through eighth aspects, communicating in the transmission occasion includes receiving, from the network node, signaling that indicates whether to apply the first set of communication parameters or the second set of communication parameters in the transmission occasion, and communicating in the transmission occasion using the first set of communication parameters or the second set of communication parameters in accordance with the signaling.

In a tenth additional aspect, alone or in combination with one or more of the first through ninth aspects, communicating in the transmission occasion includes receiving, from the network node, a bitmap that indicates whether to apply the first set of communication parameters or the second set of communication parameters in a set of transmission occasions that includes the transmission occasion, and communicating in the transmission occasion using the first set of communication parameters or the second set of communication parameters in accordance with the bitmap.

In an eleventh additional aspect, alone or in combination with one or more of the first through tenth aspects, the first set of communication parameters includes a set of offset values for the time intervals with the potential self-interference impact on the one or more harmonic frequencies relative to the second set of communication parameters for the time intervals without the potential self-interference impact on the one or more harmonic frequencies.

In a twelfth additional aspect, alone or in combination with one or more of the first through eleventh aspects, process 900 includes receiving, prior to the transmission occasion, a dynamic grant that schedules a transmission in the first set of frequencies or the second set of frequencies in accordance with a scheduling offset that satisfies a threshold related to applying the first set of communication parameters or the second set of communication parameters in the transmission occasion.

In a thirteenth additional aspect, alone or in combination with one or more of the first through twelfth aspects, process 900 includes transmitting an uplink CG skipping indication to indicate that an uplink CG transmission occasion in the first frequency band with the potential self-interference impact on downlink reception in the second frequency band will be skipped, wherein the second set of communication parameters is applied in accordance with the uplink CG skipping indication.

In a fourteenth additional aspect, alone or in combination with one or more of the first through thirteenth aspects, process 900 includes transmitting an uplink CG skipping indication to indicate that an uplink CG transmission occasion in the first frequency band with the potential self-interference impact on downlink reception in the second frequency band will be skipped, and receiving an indication to apply the second set of communication parameters in the transmission occasion in accordance with the uplink CG skipping indication.

In a fifteenth additional aspect, alone or in combination with one or more of the first through fourteenth aspects, process 900 includes transmitting a capability message that indicates a capability to support an inter-band carrier aggregation or dual connectivity mode and to apply different sets of communication parameters in different time intervals in accordance with a potential self-interference impact caused by concurrent uplink transmission in the first frequency band and downlink reception in the second frequency band, wherein the first set of communication parameters and the second set of communication parameters are received in accordance with the capability message.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a network node or an apparatus of a network node that supports full-duplex communication. Example process 1000 is an example where the apparatus or the network node (for example, network node 110) performs operations associated with a communication configuration to mitigate inter-band self-interference.

As shown in FIG. 10, in some aspects, process 1000 may include transmitting, to a UE, an uplink resource allocation spanning a first set of frequencies in a first frequency band (block 1010). For example, the network node (such as by using communication manager 150 or transmission component 1204, depicted in FIG. 12) may transmit, to a UE, an uplink resource allocation spanning a first set of frequencies in a first frequency band, as described above.

As further shown in FIG. 10, in some aspects, process 1000 may include transmitting, to the UE, a downlink resource allocation spanning a second set of frequencies in a second frequency band, wherein the second set of frequencies includes one or more harmonic frequencies impacted by self-interference from one or more fundamental frequencies in the first set of frequencies (block 1020). For example, the network node (such as by using communication manager 150 or transmission component 1204, depicted in FIG. 12) may transmit, to the UE, a downlink resource allocation spanning a second set of frequencies in a second frequency band, wherein the second set of frequencies includes one or more harmonic frequencies impacted by self-interference from one or more fundamental frequencies in the first set of frequencies, as described above.

As further shown in FIG. 10, in some aspects, process 1000 may include transmitting, to the UE, information indicating a first set of communication parameters for time intervals with a potential self-interference impact on the one or more harmonic frequencies and a second set of communication parameters for time intervals without the potential self-interference impact on the one or more harmonic frequencies (block 1030). For example, the network node (such as by using communication manager 150 or transmission component 1204, depicted in FIG. 12) may transmit, to the UE, information indicating a first set of communication parameters for time intervals with a potential self-interference impact on the one or more harmonic frequencies and a second set of communication parameters for time intervals without the potential self-interference impact on the one or more harmonic frequencies, as described above.

As further shown in FIG. 10, in some aspects, process 1000 may include communicating with the UE in a transmission occasion using the first set of communication parameters or the second set of communication parameters in accordance with a state of the uplink resource allocation and the downlink resource allocation in a time interval that includes the transmission occasion (block 1040). For example, the network node (such as by using communication manager 1206, reception component 1202, or transmission component 1204, depicted in FIG. 12) may communicate with the UE in a transmission occasion using the first set of communication parameters or the second set of communication parameters in accordance with a state of the uplink resource allocation and the downlink resource allocation in a time interval that includes the transmission occasion, as described above.

Process 1000 may include additional aspects, such as any single aspect or any combination of aspects described below or in connection with one or more other processes described elsewhere herein.

In a first additional aspect, the one or more harmonic frequencies are impacted by self-interference related to IMD caused by concurrent transmission in the one or more fundamental frequencies and reception in the one or more harmonic frequencies.

In a second additional aspect, alone or in combination with the first aspect, the one or more harmonic frequencies are second harmonics of the one or more fundamental frequencies.

In a third additional aspect, alone or in combination with one or more of the first and second aspects, the first frequency band is in a range from 410 MHz to 7.125 GHz and the second frequency band is in a range from 7.125 GHz to 24.25 GHz.

In a fourth additional aspect, alone or in combination with one or more of the first through third aspects, the uplink resource allocation and the downlink resource allocation are related to inter-band carrier aggregation operation or inter-band dual connectivity operation.

In a fifth additional aspect, alone or in combination with one or more of the first through fourth aspects, the first set of communication parameters and the second set of communication parameters are related to an SPS configuration that is in accordance with the downlink resource allocation.

In a sixth additional aspect, alone or in combination with one or more of the first through fifth aspects, the first set of communication parameters and the second set of communication parameters are related to a CG configuration that is in accordance with the uplink resource allocation.

In a seventh additional aspect, alone or in combination with one or more of the first through sixth aspects, communicating in the transmission occasion includes communicating in the transmission occasion using the first set of communication parameters in accordance with the time interval including the transmission occasion having an uplink transmission in the first frequency band or concurrent uplink transmission in the one or more fundamental frequencies and downlink reception in the one or more harmonic frequencies.

In an eighth additional aspect, alone or in combination with one or more of the first through seventh aspects, communicating in the transmission occasion includes communicating in the transmission occasion using the second set of communication parameters in accordance with the time interval including the transmission occasion not having an uplink transmission in the first frequency band or not having concurrent uplink transmission in the one or more fundamental frequencies and downlink reception in the one or more harmonic frequencies.

In a ninth additional aspect, alone or in combination with one or more of the first through eighth aspects, communicating in the transmission occasion includes transmitting, to the UE, signaling that indicates whether to apply the first set of communication parameters or the second set of communication parameters in the transmission occasion, and communicating in the transmission occasion using the first set of communication parameters or the second set of communication parameters in accordance with the signaling.

In a tenth additional aspect, alone or in combination with one or more of the first through ninth aspects, communicating in the transmission occasion includes transmitting, to the UE, a bitmap that indicates whether to apply the first set of communication parameters or the second set of communication parameters in a set of transmission occasions that includes the transmission occasion, and communicating in the transmission occasion using the first set of communication parameters or the second set of communication parameters in accordance with the bitmap.

In an eleventh additional aspect, alone or in combination with one or more of the first through tenth aspects, the first set of communication parameters includes a set of offset values for the time intervals with the potential self-interference impact on the one or more harmonic frequencies relative to the second set of communication parameters for the time intervals without the potential self-interference impact on the one or more harmonic frequencies.

In a twelfth additional aspect, alone or in combination with one or more of the first through eleventh aspects, process 1000 includes transmitting, prior to the transmission occasion, a dynamic grant that schedules a transmission in the first set of frequencies or the second set of frequencies in accordance with a scheduling offset that satisfies a threshold related to applying the first set of communication parameters or the second set of communication parameters in the transmission occasion.

In a thirteenth additional aspect, alone or in combination with one or more of the first through twelfth aspects, process 1000 includes receiving an uplink CG skipping indication to indicate that the UE will skip an uplink CG transmission occasion in the first frequency band with the potential self-interference impact on downlink reception in the second frequency band, wherein the second set of communication parameters is applied in accordance with the uplink CG skipping indication.

In a fourteenth additional aspect, alone or in combination with one or more of the first through thirteenth aspects, process 1000 includes receiving an uplink CG skipping indication to indicate that the UE will skip an uplink CG transmission occasion in the first frequency band with the potential self-interference impact on downlink reception in the second frequency band, and transmitting an indication to apply the second set of communication parameters in the transmission occasion in accordance with the uplink CG skipping indication.

In a fifteenth additional aspect, alone or in combination with one or more of the first through fourteenth aspects, process 1000 includes receiving a capability message that indicates a capability to support an inter-band carrier aggregation or dual connectivity mode and to apply different sets of communication parameters in different time intervals in accordance with a potential self-interference impact caused by concurrent uplink transmission in the first frequency band and downlink reception in the second frequency band, wherein the first set of communication parameters and the second set of communication parameters are transmitted in accordance with the capability message.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports full-duplex communication. The apparatus 1100 may be a UE 120, or a UE 120 may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 140). In some aspects, the communication manager 1106 is the communication manager 150

In some aspects, the apparatus 1100 may be configured to or operable to perform one or more operations described herein in connection with FIGS. 7-8. Additionally or alternatively, the apparatus 1100 may be configured to or operable to perform one or more processes described herein, such as process 900 of FIG. 9.

The reception component 1102 may receive communications, such as reference signals, control information, or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the UE 120 described above in connection with FIG. 1, such as a radio, one or more RF chains, one or more transceivers, or one or more modems, each of which may in turn be coupled with one or more antennas of the UE 120.

The transmission component 1104 may transmit communications, such as reference signals, control information, or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the UE 120 described above in connection with FIG. 1, such as a radio, one or more RF chains, one or more transceivers, or one or more modems, each of which may in turn be coupled with one or more antennas of the UE 120. In some aspects, the transmission component 1104 may be co-located with the reception component 1102.

The communication manager 1106 may receive or may cause the reception component 1102 to receive, from a network node, an uplink resource allocation spanning a first set of frequencies in a first frequency band. The communication manager 1106 may receive or may cause the reception component 1102 to receive, from the network node, a downlink resource allocation spanning a second set of frequencies in a second frequency band, wherein the second set of frequencies includes one or more harmonic frequencies impacted by self-interference from one or more fundamental frequencies in the first set of frequencies. The communication manager 1106 may receive or may cause the reception component 1102 to receive, from the network node, information indicating a first set of communication parameters for time intervals with a potential self-interference impact on the one or more harmonic frequencies and a second set of communication parameters for time intervals without the potential self-interference impact on the one or more harmonic frequencies. The communication manager 1106 may communicate with the network node in a transmission occasion using the first set of communication parameters or the second set of communication parameters in accordance with a state of the uplink resource allocation and the downlink resource allocation in a time interval that includes the transmission occasion. In some aspects, the communication manager 1106 may perform one or more operations described elsewhere herein as being performed by one or more components of the communication manager 1106.

In some aspects, the communication manager 1106 includes a set of components, such as a configuration component 1110. Alternatively, the set of components may be separate and distinct from the communication manager 1106. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1102 may receive, from a network node, an uplink resource allocation spanning a first set of frequencies in a first frequency band. The reception component 1102 may receive, from the network node, a downlink resource allocation spanning a second set of frequencies in a second frequency band, wherein the second set of frequencies includes one or more harmonic frequencies impacted by self-interference from one or more fundamental frequencies in the first set of frequencies. The reception component 1102 may receive, from the network node, information indicating a first set of communication parameters for time intervals with a potential self-interference impact on the one or more harmonic frequencies and a second set of communication parameters for time intervals without the potential self-interference impact on the one or more harmonic frequencies. The communication manager 1106 may communicate with the network node in a transmission occasion. For example, the configuration component 1110 may configure the reception component 1102 or the transmission component 1104 to use the first set of communication parameters or the second set of communication parameters in accordance with a state of the uplink resource allocation and the downlink resource allocation in a time interval that includes the transmission occasion. In some aspects, the communication manager 1106 may perform one or more operations described elsewhere herein as being performed by one or more components of the communication manager 1106.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports full-duplex communication. The apparatus 1200 may be a network node 110, or a network node 110 may include the apparatus 1200. In some aspects, the apparatus 1200 includes a reception component 1202, a transmission component 1204, and a communication manager 1206, which may be in communication with one another (for example, via one or more buses). As shown, the apparatus 1200 may communicate with another apparatus 1208 (such as a UE 120, a network node 110, or another wireless communication device) using the reception component 1202 and the transmission component 1204. The communication manager 1206 may be included in, or implemented via, a processing system (for example, the processing system 145). In some aspects, the communication manager 1206 is the communication manager 155.

In some aspects, the apparatus 1200 may be configured to or operable to perform one or more operations described herein in connection with FIGS. 7-8. Additionally or alternatively, the apparatus 1200 may be configured to or operable to perform one or more processes described herein, such as process 1000 of FIG. 10.

The reception component 1202 may receive communications, such as reference signals, control information, or data communications, from the apparatus 1208. The reception component 1202 may provide received communications to one or more other components of the apparatus 1200, such as the communication manager 1206. In some aspects, the reception component 1202 may perform signal processing on the received communications, and may provide the processed signals to the one or more other components in a similar manner as described above in connection with FIG. 1. In some aspects, the reception component 1202 may include one or more components of the network node 110 described above in connection with FIG. 1, such as a radio, one or more RF chains, one or more transceivers, or one or more modems, each of which may in turn be coupled with one or more antennas of the network node 110.

The transmission component 1204 may transmit communications, such as reference signals, control information, or data communications, to the apparatus 1208. In some aspects, the communication manager 1206 may generate communications and may transmit the generated communications to the transmission component 1204 for transmission to the apparatus 1208. In some aspects, the transmission component 1204 may perform signal processing on the generated communications, and may transmit the processed signals to the apparatus 1208 in a similar manner as described above in connection with FIG. 1. In some aspects, the transmission component 1204 may include one or more components of the network node 110 described above in connection with FIG. 1, such as a radio, one or more RF chains, one or more transceivers, or one or more modems, each of which may in turn be coupled with one or more antennas of the network node 110. In some aspects, the transmission component 1204 may be co-located with the reception component 1202.

The communication manager 1206 may transmit or may cause the transmission component 1204 to transmit, to a UE, an uplink resource allocation spanning a first set of frequencies in a first frequency band. The communication manager 1206 may transmit or may cause the transmission component 1204 to transmit, to the UE, a downlink resource allocation spanning a second set of frequencies in a second frequency band, wherein the second set of frequencies includes one or more harmonic frequencies impacted by self-interference from one or more fundamental frequencies in the first set of frequencies. The communication manager 1206 may transmit or may cause the transmission component 1204 to transmit, to the UE, information indicating a first set of communication parameters for time intervals with a potential self-interference impact on the one or more harmonic frequencies and a second set of communication parameters for time intervals without the potential self-interference impact on the one or more harmonic frequencies. The communication manager 1206 may communicate with the UE in a transmission occasion using the first set of communication parameters or the second set of communication parameters in accordance with a state of the uplink resource allocation and the downlink resource allocation in a time interval that includes the transmission occasion. In some aspects, the communication manager 1206 may perform one or more operations described elsewhere herein as being performed by one or more components of the communication manager 1206.

In some aspects, the communication manager 1206 includes a set of components, such as a configuration component 1210. Alternatively, the set of components may be separate and distinct from the communication manager 1206. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1204 may transmit to a UE, an uplink resource allocation spanning a first set of frequencies in a first frequency band. The transmission component 1204 may transmit, to the UE, a downlink resource allocation spanning a second set of frequencies in a second frequency band, wherein the second set of frequencies includes one or more harmonic frequencies impacted by self-interference from one or more fundamental frequencies in the first set of frequencies. The transmission component 1204 may transmit, to the UE, information indicating a first set of communication parameters for time intervals with a potential self-interference impact on the one or more harmonic frequencies and a second set of communication parameters for time intervals without the potential self-interference impact on the one or more harmonic frequencies. The communication manager 1206 may communicate with the network node in a transmission occasion. For example, the configuration component 1210 may configure the reception component 1202 or the transmission component 1204 to use the first set of communication parameters or the second set of communication parameters in accordance with a state of the uplink resource allocation and the downlink resource allocation in a time interval that includes the transmission occasion. In some aspects, the communication manager 1206 may perform one or more operations described elsewhere herein as being performed by one or more components of the communication manager 1206.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method for wireless communication by a UE, comprising: receiving, from a network node, an uplink resource allocation spanning a first set of frequencies in a first frequency band; receiving, from the network node, a downlink resource allocation spanning a second set of frequencies in a second frequency band, wherein the second set of frequencies includes one or more harmonic frequencies impacted by self-interference from one or more fundamental frequencies in the first set of frequencies; receiving, from the network node, information indicating a first set of communication parameters for time intervals with a potential self-interference impact on the one or more harmonic frequencies and a second set of communication parameters for time intervals without the potential self-interference impact on the one or more harmonic frequencies; and communicating with the network node in a transmission occasion using the first set of communication parameters or the second set of communication parameters in accordance with a state of the uplink resource allocation and the downlink resource allocation in a time interval that includes the transmission occasion.

Aspect 2: The method of Aspect 1, wherein the one or more harmonic frequencies are impacted by self-interference related to IMD caused by concurrent transmission in the one or more fundamental frequencies and reception in the one or more harmonic frequencies.

Aspect 3: The method of any of Aspects 1-2, wherein the one or more harmonic frequencies are second harmonics of the one or more fundamental frequencies.

Aspect 4: The method of any of Aspects 1-3, wherein the first frequency band is in a range from 410 MHz to 7.125 GHz and the second frequency band is in a range from 7.125 GHz to 24.25 GHz.

Aspect 5: The method of any of Aspects 1-4, wherein the uplink resource allocation and the downlink resource allocation are related to inter-band carrier aggregation operation or inter-band dual connectivity operation.

Aspect 6: The method of any of Aspects 1-5, wherein the first set of communication parameters and the second set of communication parameters are related to an SPS configuration that is in accordance with the downlink resource allocation.

Aspect 7: The method of any of Aspects 1-6, wherein the first set of communication parameters and the second set of communication parameters are related to a CG configuration that is in accordance with the uplink resource allocation.

Aspect 8: The method of any of Aspects 1-7, wherein communicating in the transmission occasion includes: communicating in the transmission occasion using the first set of communication parameters in accordance with the time interval including the transmission occasion having an uplink transmission in the first frequency band or concurrent uplink transmission in the one or more fundamental frequencies and downlink reception in the one or more harmonic frequencies.

Aspect 9: The method of any of Aspects 1-8, wherein communicating in the transmission occasion includes: communicating in the transmission occasion using the second set of communication parameters in accordance with the time interval including the transmission occasion not having an uplink transmission in the first frequency band or not having concurrent uplink transmission in the one or more fundamental frequencies and downlink reception in the one or more harmonic frequencies.

Aspect 10: The method of any of Aspects 1-9, wherein communicating in the transmission occasion includes: receiving, from the network node, signaling that indicates whether to apply the first set of communication parameters or the second set of communication parameters in the transmission occasion; and communicating in the transmission occasion using the first set of communication parameters or the second set of communication parameters in accordance with the signaling.

Aspect 11: The method of any of Aspects 1-10, wherein communicating in the transmission occasion includes: receiving, from the network node, a bitmap that indicates whether to apply the first set of communication parameters or the second set of communication parameters in a set of transmission occasions that includes the transmission occasion; and communicating in the transmission occasion using the first set of communication parameters or the second set of communication parameters in accordance with the bitmap.

Aspect 12: The method of any of Aspects 1-11, wherein the first set of communication parameters includes a set of offset values for the time intervals with the potential self-interference impact on the one or more harmonic frequencies relative to the second set of communication parameters for the time intervals without the potential self-interference impact on the one or more harmonic frequencies.

Aspect 13: The method of any of Aspects 1-12, further comprising: receiving, prior to the transmission occasion, a dynamic grant that schedules a transmission in the first set of frequencies or the second set of frequencies in accordance with a scheduling offset that satisfies a threshold related to applying the first set of communication parameters or the second set of communication parameters in the transmission occasion.

Aspect 14: The method of any of Aspects 1-13, further comprising: transmitting an uplink CG skipping indication to indicate that an uplink CG transmission occasion in the first frequency band with the potential self-interference impact on downlink reception in the second frequency band will be skipped, wherein the second set of communication parameters is applied in accordance with the uplink CG skipping indication.

Aspect 15: The method of any of Aspects 1-14, further comprising: transmitting an uplink CG skipping indication to indicate that an uplink CG transmission occasion in the first frequency band with the potential self-interference impact on downlink reception in the second frequency band will be skipped; and receiving an indication to apply the second set of communication parameters in the transmission occasion in accordance with the uplink CG skipping indication.

Aspect 16: The method of any of Aspects 1-15, further comprising: transmitting a capability message that indicates a capability to support an inter-band carrier aggregation or dual connectivity mode and to apply different sets of communication parameters in different time intervals in accordance with a potential self-interference impact caused by concurrent uplink transmission in the first frequency band and downlink reception in the second frequency band, wherein the first set of communication parameters and the second set of communication parameters are received in accordance with the capability message.

Aspect 17: A method of wireless communication performed by a network node, comprising: transmitting, to a UE, an uplink resource allocation spanning a first set of frequencies in a first frequency band; transmitting, to the UE, a downlink resource allocation spanning a second set of frequencies in a second frequency band, wherein the second set of frequencies includes one or more harmonic frequencies impacted by self-interference from one or more fundamental frequencies in the first set of frequencies; transmitting, to the UE, information indicating a first set of communication parameters for time intervals with a potential self-interference impact on the one or more harmonic frequencies and a second set of communication parameters for time intervals without the potential self-interference impact on the one or more harmonic frequencies; and communicating with the UE in a transmission occasion using the first set of communication parameters or the second set of communication parameters in accordance with a state of the uplink resource allocation and the downlink resource allocation in a time interval that includes the transmission occasion.

Aspect 18: The method of Aspect 17, wherein the one or more harmonic frequencies are impacted by self-interference related to IMD caused by concurrent transmission in the one or more fundamental frequencies and reception in the one or more harmonic frequencies.

Aspect 19: The method of any of Aspects 17-18, wherein the one or more harmonic frequencies are second harmonics of the one or more fundamental frequencies.

Aspect 20: The method of any of Aspects 17-19, wherein the first frequency band is in a range from 410 MHz to 7.125 GHz and the second frequency band is in a range from 7.125 GHz to 24.25 GHz.

Aspect 21: The method of any of Aspects 17-20, wherein the uplink resource allocation and the downlink resource allocation are related to inter-band carrier aggregation operation or inter-band dual connectivity operation.

Aspect 22: The method of any of Aspects 17-21, wherein the first set of communication parameters and the second set of communication parameters are related to an SPS configuration that is in accordance with the downlink resource allocation.

Aspect 23: The method of any of Aspects 17-22, wherein the first set of communication parameters and the second set of communication parameters are related to a CG configuration that is in accordance with the uplink resource allocation.

Aspect 24: The method of any of Aspects 17-23, wherein communicating in the transmission occasion includes: communicating in the transmission occasion using the first set of communication parameters in accordance with the time interval including the transmission occasion having an uplink transmission in the first frequency band or concurrent uplink transmission in the one or more fundamental frequencies and downlink reception in the one or more harmonic frequencies.

Aspect 25: The method of any of Aspects 17-24, wherein communicating in the transmission occasion includes: communicating in the transmission occasion using the second set of communication parameters in accordance with the time interval including the transmission occasion not having an uplink transmission in the first frequency band or not having concurrent uplink transmission in the one or more fundamental frequencies and downlink reception in the one or more harmonic frequencies.

Aspect 26: The method of any of Aspects 17-25, wherein communicating in the transmission occasion includes: transmitting, to the UE, signaling that indicates whether to apply the first set of communication parameters or the second set of communication parameters in the transmission occasion; and communicating in the transmission occasion using the first set of communication parameters or the second set of communication parameters in accordance with the signaling.

Aspect 27: The method of any of Aspects 17-26, wherein communicating in the transmission occasion includes: transmitting, to the UE, a bitmap that indicates whether to apply the first set of communication parameters or the second set of communication parameters in a set of transmission occasions that includes the transmission occasion; and communicating in the transmission occasion using the first set of communication parameters or the second set of communication parameters in accordance with the bitmap.

Aspect 28: The method of any of Aspects 17-27, wherein the first set of communication parameters includes a set of offset values for the time intervals with the potential self-interference impact on the one or more harmonic frequencies relative to the second set of communication parameters for the time intervals without the potential self-interference impact on the one or more harmonic frequencies.

Aspect 29: The method of any of Aspects 17-28, further comprising: transmitting, prior to the transmission occasion, a dynamic grant that schedules a transmission in the first set of frequencies or the second set of frequencies in accordance with a scheduling offset that satisfies a threshold related to applying the first set of communication parameters or the second set of communication parameters in the transmission occasion.

Aspect 30: The method of any of Aspects 17-29, further comprising: receiving an uplink CG skipping indication to indicate that the UE will skip an uplink CG transmission occasion in the first frequency band with the potential self-interference impact on downlink reception in the second frequency band, wherein the second set of communication parameters is applied in accordance with the uplink CG skipping indication.

Aspect 31: The method of any of Aspects 17-30, further comprising: receiving an uplink CG skipping indication to indicate that the UE will skip an uplink CG transmission occasion in the first frequency band with the potential self-interference impact on downlink reception in the second frequency band; and transmitting an indication to apply the second set of communication parameters in the transmission occasion in accordance with the uplink CG skipping indication.

Aspect 32: The method of any of Aspects 17-31, further comprising: receiving a capability message that indicates a capability to support an inter-band carrier aggregation or dual connectivity mode and to apply different sets of communication parameters in different time intervals in accordance with a potential self-interference impact caused by concurrent uplink transmission in the first frequency band and downlink reception in the second frequency band, wherein the first set of communication parameters and the second set of communication parameters are transmitted in accordance with the capability message.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, an uplink resource allocation spanning a first set of frequencies in a first frequency band;
receive, from the network node, a downlink resource allocation spanning a second set of frequencies in a second frequency band, wherein the second set of frequencies includes one or more harmonic frequencies impacted by self-interference from one or more fundamental frequencies in the first set of frequencies;
receive, from the network node, information indicating a first set of communication parameters for time intervals with a potential self-interference impact on the one or more harmonic frequencies and a second set of communication parameters for time intervals without the potential self-interference impact on the one or more harmonic frequencies; and
communicate with the network node in a transmission occasion using the first set of communication parameters or the second set of communication parameters in accordance with a state of the uplink resource allocation and the downlink resource allocation in a time interval that includes the transmission occasion.

2. The UE of claim 1, wherein the one or more harmonic frequencies are impacted by self-interference related to intermodulation distortion (IMD) caused by concurrent transmission in the one or more fundamental frequencies and reception in the one or more harmonic frequencies.

3. The UE of claim 1, wherein the one or more harmonic frequencies are second harmonics of the one or more fundamental frequencies.

4. The UE of claim 1, wherein the first frequency band is in a range from 410 megahertz (MHz) to 7.125 gigahertz (GHz) and the second frequency band is in a range from 7.125 GHz to 24.25 GHz.

5. The UE of claim 1, wherein the uplink resource allocation and the downlink resource allocation are related to inter-band carrier aggregation operation or inter-band dual connectivity operation.

6. The UE of claim 1, wherein the first set of communication parameters and the second set of communication parameters are related to a semi-persistent scheduling (SPS) configuration that is in accordance with the downlink resource allocation.

7. The UE of claim 1, wherein the first set of communication parameters and the second set of communication parameters are related to a configured grant (CG) configuration that is in accordance with the uplink resource allocation.

8. The UE of claim 1, wherein communicating in the transmission occasion includes:
communicating in the transmission occasion using the first set of communication parameters in accordance with the time interval including the transmission occasion having an uplink transmission in the first frequency band or concurrent uplink transmission in the one or more fundamental frequencies and downlink reception in the one or more harmonic frequencies.

9. The UE of claim 1, wherein to communicate in the transmission occasion, the processing system is configured to cause the UE to:
communicate in the transmission occasion using the second set of communication parameters in accordance with the time interval including the transmission occasion not having an uplink transmission in the first frequency band or not having concurrent uplink transmission in the one or more fundamental frequencies and downlink reception in the one or more harmonic frequencies.

10. The UE of claim 1, wherein to communicate in the transmission occasion, the processing system is configured to cause the UE to:
receive, from the network node, signaling that indicates whether to apply the first set of communication parameters or the second set of communication parameters in the transmission occasion; and
communicate in the transmission occasion using the first set of communication parameters or the second set of communication parameters in accordance with the signaling.

11. The UE of claim 1, wherein to communicate in the transmission occasion, the processing system is configured to cause the UE to:
receive, from the network node, a bitmap that indicates whether to apply the first set of communication parameters or the second set of communication parameters in a set of transmission occasions that includes the transmission occasion; and
communicate in the transmission occasion using the first set of communication parameters or the second set of communication parameters in accordance with the bitmap.

12. The UE of claim 1, wherein the first set of communication parameters includes a set of offset values for the time intervals with the potential self-interference impact on the one or more harmonic frequencies relative to the second set of communication parameters for the time intervals without the potential self-interference impact on the one or more harmonic frequencies.

13. The UE of claim 1, wherein the processing system is configured to cause the UE to:
receive, prior to the transmission occasion, a dynamic grant that schedules a transmission in the first set of frequencies or the second set of frequencies in accordance with a scheduling offset that satisfies a threshold related to applying the first set of communication parameters or the second set of communication parameters in the transmission occasion.

14. The UE of claim 1, wherein the processing system is configured to cause the UE to:
transmit an uplink configured grant (CG) skipping indication to indicate that an uplink CG transmission occasion in the first frequency band with the potential self-interference impact on downlink reception in the second frequency band will be skipped, wherein the second set of communication parameters is applied in accordance with the uplink CG skipping indication.

15. The UE of claim 1, wherein the processing system is configured to cause the UE to:
transmit an uplink configured grant (CG) skipping indication to indicate that an uplink CG transmission occasion in the first frequency band with the potential self-interference impact on downlink reception in the second frequency band will be skipped; and
receive an indication to apply the second set of communication parameters in the transmission occasion in accordance with the uplink CG skipping indication.

16. The UE of claim 1, wherein the processing system is configured to cause the UE to:
transmit a capability message that indicates a capability to support an inter-band carrier aggregation or dual connectivity mode and to apply different sets of communication parameters in different time intervals in accordance with a potential self-interference impact caused by concurrent uplink transmission in the first frequency band and downlink reception in the second frequency band, wherein the first set of communication parameters and the second set of communication parameters are received in accordance with the capability message.

17. A network node, comprising:
a processing system that includes one or more processors and one or more code-storing memories coupled with the one or more processors, the processing system configured to cause the network node to:
transmit, to a user equipment (UE), an uplink resource allocation spanning a first set of frequencies in a first frequency band;
transmit, to the UE, a downlink resource allocation spanning a second set of frequencies in a second frequency band, wherein the second set of frequencies includes one or more harmonic frequencies impacted by self-interference from one or more fundamental frequencies in the first set of frequencies;
transmit, to the UE, information indicating a first set of communication parameters for time intervals with a potential self-interference impact on the one or more harmonic frequencies and a second set of communication parameters for time intervals without the potential self-interference impact on the one or more harmonic frequencies; and
communicate with the UE in a transmission occasion using the first set of communication parameters or the second set of communication parameters in accordance with a state of the uplink resource allocation and the downlink resource allocation in a time interval that includes the transmission occasion.

18. The network node of claim 17, wherein the first set of communication parameters and the second set of communication parameters are related to a semi-persistent scheduling (SPS) configuration that is in accordance with the downlink resource allocation.

19. The network node of claim 17, wherein the first set of communication parameters and the second set of communication parameters are related to a configured grant (CG) configuration that is in accordance with the uplink resource allocation.

20. A method for wireless communication by a user equipment (UE), comprising:
receiving, from a network node, an uplink resource allocation spanning a first set of frequencies in a first frequency band;
receiving, from the network node, a downlink resource allocation spanning a second set of frequencies in a second frequency band, wherein the second set of frequencies includes one or more harmonic frequencies impacted by self-interference from one or more fundamental frequencies in the first set of frequencies;
receiving, from the network node, information indicating a first set of communication parameters for time intervals with a potential self-interference impact on the one or more harmonic frequencies and a second set of communication parameters for time intervals without the potential self-interference impact on the one or more harmonic frequencies; and
communicating with the network node in a transmission occasion using the first set of communication parameters or the second set of communication parameters in accordance with a state of the uplink resource allocation and the downlink resource allocation in a time interval that includes the transmission occasion.
